(19) United States
(12) Patent Application Publication
(10) Pub. No.: US 2009/0240629 A1
(43) Pub. Date: Sep. 24, 2009

(54) System and method for accelerating convergence between buyers and sellers of products

(76) Inventors: Jie Xie, Rego Park, NY (US); Shuyi Zhu, Ann Arbor, MI (US)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/383,176

(22) Filed: Mar. 20, 2009

Related U.S. Application Data
(60) Provisional application No. 61/070,325, filed on Mar. 21, 2008.

(51) Int. Cl. G06Q 30/00; G06Q 10/00

(52) U.S. Cl. 705/80; 705/26; 705/10

(57) ABSTRACT

A system and method for reducing the distance of the understanding and expectation between a buyer and seller for a price of a particular product that is offered for sale. The system and method permit buyer to use their volume purchase power to lower the price of demanded product, and pay only the fair market value of the product in that the price is much lower than the price expectation or requirement of the buyer. Conversely, the system and method permit sellers to reach a targeted market in which a group of buyers are available for desired product. The seller is provided with the benefits associated with low cost competition by reducing the distribution cost and increasing the operation efficiency, such as increased inventory turnover rate, based on the advantages associated with volume sales.

### CROSS-REFERENCE TO RELATED APPLICATIONS

This application claims priority from U.S. Provisional Application Ser. No. 61/070,325 filed Mar. 21, 2008, the content of which is hereby incorporated by reference in its entirety.

### BACKGROUND OF THE INVENTION

1. Field of the Invention

The present invention generally relates to the field of electronic commerce and, more particularly, to a system and method for reducing the distance of the understanding and expectation between a buyer and seller for a price of a particular product that is offered for sale.

2. Description of the Related Art

A large number of on-line business models are available for changing the purchasing behavior of consumers. Each of these business models have their own associated disadvantages in the current e-commerce environment. For example, people seeking to make purchases, i.e., buyers, spend an excessive amount of time performing Internet searches attempting to find the most reasonable price for specific products for which they perform their searches.

Conversely, businesses or individuals seeking to sell their products, i.e., sellers, spend a considerable amount of money to market themselves in an attempt to attract suitable buyers.

Given, the current state of the e-commerce environment, it is apparent there is a need to provide an efficient market to assist the buyers in obtaining a lower price to fair market value for a product and for permitting the sellers to maximize sales volume with based on a viable cost leadership strategy.

### SUMMARY OF THE INVENTION

Disclosed are a system and method for reducing the distance of the understanding and expectation between a buyer and seller for a price of a particular product that is offered for sale.

In accordance with the invention, a website is provided which provides significant and previously unavailable benefits to both a buyer and a seller. On the buyer side, he/she is permitted to use volume purchase power to lower the price of product in specific products in demand, and enjoy only paying the fair market value (FMV) of the product at a price that is much lower than the expectation of the buyer. The seller, on the other hand, can easily reach the targeted market in which a group of buyers are available for the desired product. Moreover, the seller can obtain the benefits associated with low cost competition by reducing the distribution cost and increasing the operation efficiency like increasing inventory turnover rate and so on through volume sale advantage. The low cost competition provides a benefit to sellers and buyers.

The website provided in accordance with the invention provides many sellers. However, only one seller is provided for any one particular product, which thereby obtains the exclusive direct sale right, is allowed to sell the particular product on-line or over the Internet. Each seller competes for the right to make the direct sale. The seller is also provided with a seller auction window. Thus, for each seller, all of them will receive the price information of the buyers that is a stack of different price ranges for the same product having a group buyer associated with each price range (“Price Stack”). An auction model is used on the seller side of the transaction, where the auction model opens an auction window to all sellers within a predefined time interval.

The seller offering the lowest acceptable price for the product within the predefined time interval that the auction window is open will win the transaction, and the auction window will then be closed. Moreover, all buyers who offered the price, not only on the lowest price but also above the lowest price, will obtain the same lowest price and, thus, close the transaction.

The predefined time interval that is associated with the auction window is adjustable. The market varies across specific industries and the type of products. The creation of the market in accordance with the method and system, promotes a smooth and efficient environment for making sales and purchases by adjusting the predefined time interval of the auction window for each particular product based on the number of buyers and sellers that are available in the market. Here, the market is monitored and the predefined time interval is adjusted to a shorter interval for an active market and a longer interval for a slower market. As a result, it becomes possible to promote competition among different sized sellers to prevent the buyers from losing advantages associated with volume purchasing and to prevent the sellers from running out of inventory in accordance with the above-mentioned no back-order policy.

A dynamic and efficient market system is implemented. Buyers receive the most recent auction result via email or text message in accordance with a buyer pre-selected notification frequency, such as after every deal, every day or every two days, and can adjust the maximum price according to the results of an auction. The sellers are also provided with the ability to adjust their biding price based on the number of available buyers and their offering price. In this manner, a FMV is eventually established that is equivalent to the supply and demand for the product.

Other objects and features of the present invention will become apparent from the following detailed description considered in conjunction with the accompanying drawings. It is to be understood, however, that the drawings are designed solely for purposes of illustration and not as a definition of the limits of the invention. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is a schematic block diagram of the system in accordance with the invention;

FIG. 2 is a schematic block diagram illustrating the system configuration for implementing the direct sale model of FIG. 1;

FIG. 3 is schematic block diagram illustrating the system configuration for implementing the auction model of FIG. 1;

FIG. 4 is a block diagram illustrating the operational flow of the auction model of FIG. 3; and

FIGS. 5-26 are screen captures of a transaction process in accordance with the system and method of the invention.

### DETAILED DESCRIPTION OF THE EXEMPLARY EMBODIMENTS

Disclosed are a system and method for reducing the distance of the understanding and expectation between a buyer and seller for a price of a particular product that is offered for sale.

A website is created to provide an electronic market that permits a group of buyers and sellers to converge and arrive at a fair market value (FMV) for a particular product based on the equivalent supply and demand for the product. A plurality of transaction models are implemented at a website. Preferably, two types of transaction models are implemented, i.e., a direct sale model and an auction sale model.

In cases where the buyer makes a direct purchase, the buyer performs a search for the particular product, and obtains product information and the lowest price that is acceptable to the seller. Here, the lowest acceptable price is displayed as a “Buy Now” price at the website. If the buyer is satisfied with the Buy Now price, then he/she can purchase the product immediately. Other products are simultaneously provided from the same seller to the buyer for purchase by the buyer. Here, the buyer can purchase the additional products in the same transaction to save shipping costs.

The buyer is also provided with the ability to make the purchase while offering a maximum acceptable price. Here, the buyer also can submit a counter-offer with a maximum price that he/she will pay for the particular product. Pursuant to this feature, the buyer is required to provide payment information to guarantee the purchase once the product with the associated maximum price has been reached. At the same time that the counter-offer is submitted, the buyer may also chose a time period in which the offer should remain valid, a notification method, and the frequency that he/she will be informed of the auction result, such as after every deal, every day or every two days. Moreover, the buyer is provided with the ability to adjust his/her maximum purchase price according to the market response. In the preferred embodiment, the buyer is provided with a suggested period that is at a more intensive frequency to the rush buyer.

The buyer is also provided with the ability to invite other buyers, and thereby share his/her purchase information with these additional buyers to strengthen his/her position during the counter-offering process. Thus, a greater number of buyers that remain with the same price or price range ensures the possibility that the seller will accept the price or price range.

The price range is located in a Price Stack. Consequently, after the buyer submits a maximum price that he/she is willing to pay for the product, which is a price lower than the Buy Now price, the price information is accumulated and grouped as a price range in the Price Stack. This price range is adjustable according to the price level of the particular product and the gap between the expectations of the buyers.

Specifically, the Price Stack is a composite of different price ranges for a particular product, where a group of buyers is associated with each price range. In accordance with the disclosed invention, the Price Stack is dynamic to reflect current market conditions, which indicates the demand from buyers on each price range, and is only visible to sellers.

When a seller wishes to make a direct sale, the seller offering the lowest price that is the Buy Now price for the buyer is provided with the benefits associated with performing the direct sale to the buyer. The website provided in accordance with the invention provides many sellers. However, only one seller is provided for any one particular product, which thereby obtains the exclusive direct sale right, is allowed to sell the particular product on-line or over the Internet.

Each seller competes for the right to make the direct sale. Multiple statuses are associated with each seller for selling items. Preferably, the status comprises on-line items, waiting list items and watch list items. On-line items are items for which the seller has obtained an exclusive right to perform a direct sale at the website, with certain inventory level maintenance requirements as defined by a no back-order policy. Waiting list items are items having one of next several lowest prices and maintenance of a certain inventory level, and are ready for sale if they become the on-line item due to exhaustion of the inventory or the occurrence of a change in the price of the previous on-line item. Watch list items are items that do not have the above-mentioned price features, and no inventory level maintenance requirement, and are being held until the seller develops a new sales strategy. The status of an item being sold can be changed on the supply side based on the market conditions.

The seller is also provided with a seller auction window. Thus, for each seller, all of them will receive the price information of the buyers that is a stack of different price ranges for the same product having a group buyer associated with each price range (“Price Stack”). An auction model is used on the seller side of the transaction, where the auction model opens an auction window to all sellers within a predefined time interval. When the auction window opens, the Price Stack becomes frozen, i.e., the quantity on each price range remains unchanged, and the sellers begin placing their asking price or start to bid their price. The process of counter-offering the maximum acceptable price is never interrupted for the buyers, even though the auction window may be open. The seller offering the lowest acceptable price for the product within the predefined time interval that the auction window is open will win the transaction, and the auction window will then be closed. Moreover, all buyers who counter-offered the price, not only on the lowest price but also above the lowest price, will obtain the same lowest price and, thus, close the transaction.

After the transaction is closed, a confirmation email is sent to inform the buyer of the final price. Here, all of the information of the buyer, including purchase volume, shipping address, and payment information, is provided to the seller for transaction processing.

The predefined time interval that is associated with the auction window is adjustable. The market varies across specific industries and the type of products. The creation of the market in accordance with the method and system, promotes a smooth and efficient environment for making sales and purchases by adjusting the predefined time interval of the auction window for each particular product based on the number of buyers and sellers that are available in the market. Here, the market is monitored and the predefined time interval is adjusted to a shorter interval for an active market and a longer interval for a slower market. As a result, it becomes possible to promote competition among different sized sellers to prevent the buyers from losing advantages associated with volume purchasing and to prevent the sellers from running out of inventory in accordance with the above-mentioned no back-order policy.

In accordance with the invention, a dynamic and efficient market system is implemented. Here, buyers will receive the most recent auction result via email or text message in accordance with a buyer pre-selected notification frequency, such as after every deal, every day or every two days, and can adjust the maximum price according to the results of an auction. Consequently, the Price Stack becomes adjusted to a point that is closer to the price that the sellers are willing to accept for their products after every auction window closed. The sellers are also provided with the ability to adjust their biding price based on the number of available buyers and their counter-offering price. In this manner, a FMV is eventually established that is equivalent to the supply and demand for the product.

The system and method provides an enhanced market, as well as the potential to expand this enhanced market. The buyer can upload the product information to the website and invite or wait for additional buyers to join the market, if the demanded product is not available on the website. In addition, the seller can also upload the product information to the website, as well as the price that he/she is willing to accept to thereby attract potential buyers. A web-master function is provided that permits continual monitoring of the uploaded products, and provides a way to determine the suitability of the product for the market. In the case of a product that is suitable for the market, if the product is uploaded by seller, then the product becomes available on the website immediately. All transaction methods including direct sale and auction model apply to this product. However, if the buyer uploads the product information, then it is placed in a demanded product database, where this database is searchable by the buyer and seller. Simultaneously, the number of visitors is counted, and their contact information collected. After a seller uploads the product information and provide a price that he will accept for this particular product, the product is removed from the demanded product database and made available on-line for all types of transactions including direct sale and auction sales. A notification is sent to all potential buyers who leave their contact information with the website. In this manner, it becomes possible to establish a new market.

A strict verification procedure for a new seller and a credit rating system for all sellers is established to control the quality of the sellers. Here, sellers who wish to open an account at the website must pass an ID verification and credit check process, and consent to the related policies including inventory control policy. The inventory control policy includes requests that the seller maintain a certain inventory level to avoid back-orders. It should be noted that the system and method forbids the occurrence of back-orders in the created market because the occurrence of back-orders will undermine the reliability of the system due to an excessive number of unavailable products. An internal credit rating system is used for each seller to assign an initial rating to a new seller based on the results of the credit check and to also adjust the credit rating based on feedback from buyers. The internal credit rating of the seller affects the fee schedule, where it will be readily appreciated that a lower service charge will be maintained for a seller with a good credit rating and a higher service charge will be provide to sellers with a bad credit rating. Here, a threshold is set for the credit rating. In this case, sellers having a credit rating that exceeds the threshold will be excluded from the market.

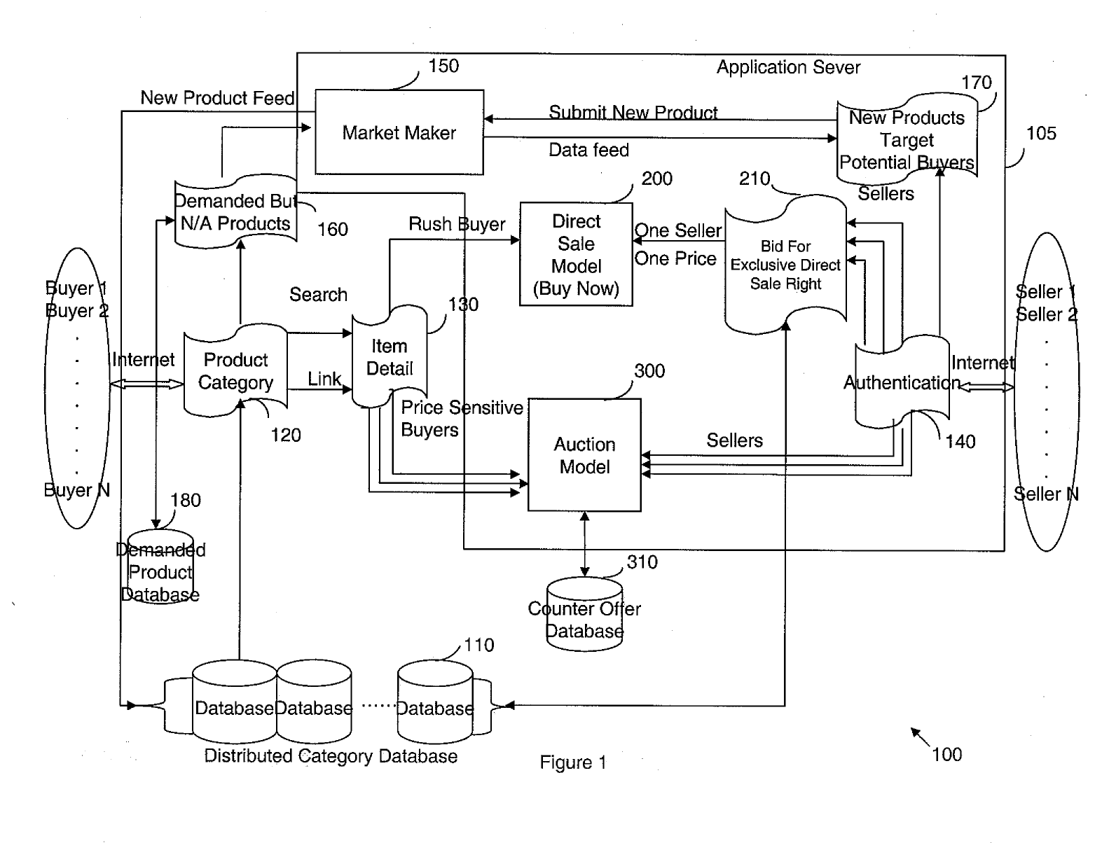

FIG. 1 is a schematic block diagram of the system 100 in accordance with the invention. The system 100 includes a distributed database 110 that contains major product categories. The distributed category database 110 and corresponding computer system utilize the same operational concept to separate each other to increase processing efficiency.

The list 130 contains detailed information of product demanded by the buyer along with an associated “Buy Now” price that permits the buyer to make an immediate purchase if the buyer is satisfied with this price.

A strict verification procedure for a new seller and a credit rating system for all sellers are established to control the quality of the sellers. The authentication module 140 is used to perform the verification of the sellers.

A market maker module 150 is provided in which the buyer can upload 160 the product information to the website and invite and/or wait for other buyers to join the market, if the product that is in demand is not available at the website. The new products target potential buyers module 170 permits the seller to also upload the product information to the website, as well as his/her offer price to attract potential buyers. The system and method provides a web-master with the ability to monitor the uploaded products and determine their suitability for the market. For a suitable product, if it is uploaded by the seller, then the product becomes available at the website immediately, and all transaction methods including the direct sale model 200 and the auction model 300 are applicable to this product. Alternatively, if the buyer uploads the product, then the product information will be placed into the demanded product database 180, which is searchable by both the buyers and the sellers. Concurrently, a count is performed of the number of visitors to the website, and their contact information is collected. Once a seller uploads the product information and offers a price for this particular product, the product is removed from the demanded product database 180 and added to the distributed database 110. The demanded product becomes available on-line for all types of transactions, including the direct sale model 200 and the auction sale model 300, each of which are described in detail subsequently. A notification is sent to all potential buyers who leave their contact information with the website. In this manner, it becomes possible to establish a new market.

A buyer may use a search engine to identify the demanded product 120 based on whether the product is located in the distributed database 110. If there are no products identified in the distributed 110, a search result against the demanded product database 180 is provided simultaneously. The buyer can either leave his/her contact information if the demanded product is identified or he/she can leave product information with the website and become notified at a later point in time of its availability when the related market is established.

The lowest acceptable price is displayed as the “Buy Now” price at the website. If the buyer is in a hurry or is satisfied with the Buy Now price, then he/she can go to the direct sale model 200 to make the purchase immediately.

The seller, who offers the lowest price or bids for an exclusive direct sale right 210, which is the Buy Now price shown to the buyer, can enjoy the direct sale to the buyer. A database is also provided for storage of price counter offers from buyers, i.e., buyers use volume purchasing power granted by the auction sale model 300 to counter-offer prices which were stored in the counter offer database 310.

In accordance with the contemplated system 100 and method of the invention, at least the processing associated with market maker 150, the direct sale model 200 the auction sale model 300, as well as the processing associated with bidding for the exclusive direct sale right, authentication and the uploading of new products by the seller is implemented in an application server 105. It should be understood that although the application server 105 is described with respect to the foregoing components, it is possible to locate other components in other servers in accordance with distributed computing standards. In addition, other components of the system and method of the invention may also be incorporated into the application server 105.

Moreover, dashed lines are used to indicate the components that are included in the application server 105. Here, the application server 105, in implemented in an n-tier architecture, and is a server that hosts an application programming interface (API) to provide the business logic and business processes for implementation of the method that is implemented in the system 100 of the invention. An API is a set of routines, data structures, object classes and/or protocols provided by libraries and/or operating system services to support the building of applications.

One exemplary application server 105 is a J2EE or Java EE 5 application server. Other Java Enterprise Edition (JEE) application servers are WebSphere Application Server and WebSphere Application Server Community Edition (IBM), Sybase Enterprise Application Server (Sybase Inc), WebLogic Server (BEA), JBoss (Red Hat), JRun (Adobe Systems), Apache Geronimo (Apache Software Foundation), Oracle OC4J (Oracle Corporation), Sun Java System Application Server (based on GlassFish Application Server) (Sun Microsystems), SAP Netweaver AS (ABAP/Java) (SAP), and Glassfish Application Server.

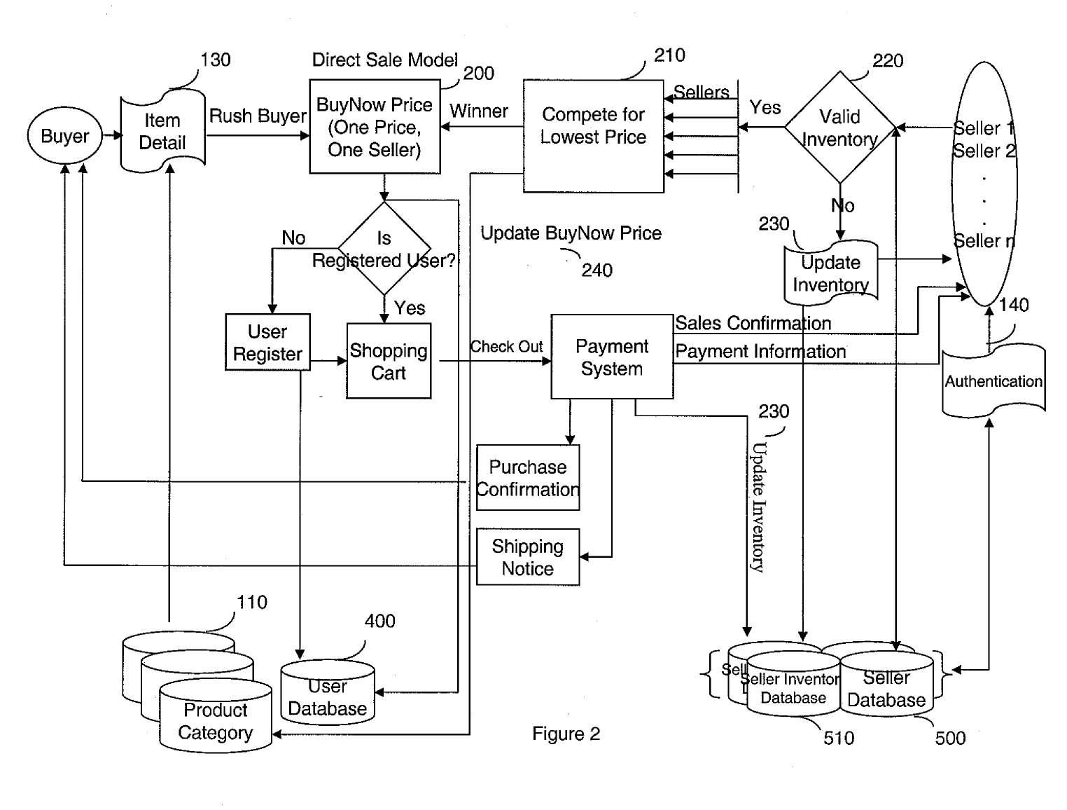

FIG. 2 is a schematic block diagram illustrating the system configuration for implementing the direct sale model 200 of FIG. 1. A main website that is provided to the users utilizes a distributed structure for website development. Consequently, each major product category is provided with its own sub-website that is independent from the sub-website of other product categories. Also provided with the sub-website is an access link that provides a connection to the main website. A search engine utilizes a distributed method to search the information requested by buyers or sellers at each separate database server (not shown) simultaneously to increase search efficiency, where each product category has a corresponding database that is located in a respective database server.

As stated previously, a buyer may use the search engine to identify demanded product 120 based on whether the product is located in distributed database 110. If there are no products identified in the distributed 110, a search result against the demanded product database 180 is provided simultaneously. The buyer either leave his/her contact information if the demanded product is identified or he/she can leave product information with the website and become notified at a later point in time of its availability when the related market is established. On the seller side, the seller can also upload the new product information 170 to the website, as well as his required price that he/she is willing to thereby attract potential buyers.

The lowest acceptable price is displayed as the “Buy Now” price at the website. If the buyer is in a hurry or is satisfied with the Buy Now price, then he/she can go to the direct sale model 200 to make the purchase immediately.

The seller, who offers the lowest price or bids for an exclusive direct sale right 210, which is the Buy Now price shown to the buyer, can enjoy the direct sale to the buyer. It should be noted that there are many sellers available to the buyer via the website. However, only one seller is provided for a any one particular product, which obtains the exclusive direct sale right, can sell the product on-line.

With specific reference to FIG. 2, the distributed category database 110 and corresponding computer system of the buyer (not shown) utilize the same operational concept to separate each other to increase processing efficiency. Buyers are permitted to identify categories of products 120 so that they can demand and make purchase decisions.

A strict verification procedure for a new seller and a credit rating system for all sellers are established to control the quality of the sellers. The authentication module 140 is used to perform the verification of the sellers. Consequently, sellers who wish to open an account at the website must pass an ID verification and a credit check process, and consent to the related policies including an inventory control policy, where sellers are required to maintain a certain inventory level to avoid the creation of back-orders, i.e. does the seller have a valid inventory 220. If sellers do not have sufficient inventory, then sellers are provided with the opportunity to update their inventory 230 information such that they can become eligible to compete for the right to make the direct sale. The inventory information is also updated upon completion of each purchase. It should be noted that the system and method forbids the occurrence of back-orders in the created market because the occurrence of back-orders will undermine the reliability of the system due to an excessive number of unavailable products.

An internal credit rating system is used so as to assign to each seller an initial rating to a new seller based on the results of the credit check and to also adjust the credit rating based on feedback from buyers. The internal credit rating of the seller affects a predetermined fee schedule, where it will be readily appreciated that a lower service charge will be maintained for a seller with a good credit rating and a higher service charge will be provided to sellers with a bad credit rating. Here, a threshold is set for the credit rating. Consequently, sellers having a credit rating that exceeds the threshold will be excluded from the market.

The list 130 contains detailed information of product demanded by the buyer along with an associated “Buy Now” price that permits the buyer to make an immediate purchase if the buyer is satisfied with this price. Alternatively, the buyer may make a counter price offer to provide a maximum price that he/she is willing to accept. The buyer may simultaneously choose a time-period during which the counter offer is valid, the notification method, and the frequency he/she will be informed of an auction result that is created due to the submittal of the counter offer, such as after every deal, every day or every two days. In accordance with the disclosed system 100, the buyer may adjust his/her maximum price according to the response from the market. If the buyer is a rush buyer, then he/she can utilize the direct sale model 200 to make an immediate purchase. Preferably, the buyer is provided with a suggested period that is at a more intensive frequency to such a rush buyer. Before being provided with the ability to make purchases, however, buyers are required to register with the system and provide their information that is stored in the user database 400. The process associated with user validation and authentication is performed in accordance with standard authentication procedures. Therefore, if a buyer is not authorized to access the system to make purchases, they will be denied the ability to checkout their product in the conventional shopping cart and complete their purchase until they have registered.

Each seller competes 210 for the right to make the direct sale. When a seller wishes to make a direct sale, the seller offering the lowest price that is the Buy Now price for the buyer among available sellers is provided with the benefits associated with performing the direct sale to the buyer. When the lowest price becomes available, the Buy Now price in the product category database 110 is updated with a new Buy Now price 240. The website provided in accordance with the invention provides many sellers. However, only one seller is provided for any one particular product, which thereby obtains the exclusive direct sale right, is allowed to sell the particular product on-line or over the Internet.

The seller database 500 is used to store all information pertaining to the seller, such as store name, location, phone number or email address, as well as their credit rating. Seller inventory database 510 is used to store the product information associated with the products for sale that are provided by each seller.

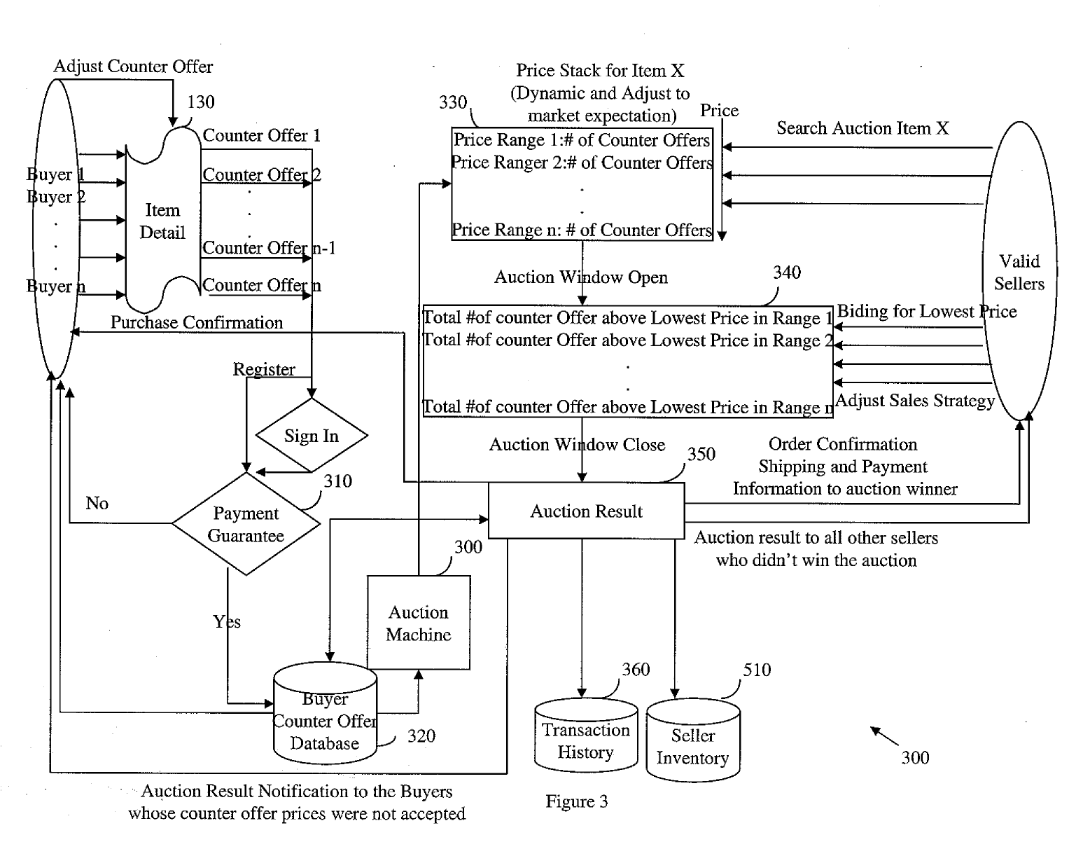

FIG. 3 is schematic block diagram illustrating the system configuration for implementing the auction model 300 of FIG. 1. Referring to FIG. 3, the list 130 contains the detailed information of product demanded by the buyer along with an associated “Buy Now” price that permits the buyer to make an immediate purchase if the buyer is satisfied with this price.

As described with reference to FIG. 2, the buyer may alternatively make a counter price offer to provide a maximum price that he/she is willing to accept, where the buyer may simultaneously choose a time-period during which the counter offer is valid, the notification method, and the frequency he/she will be informed of an auction result that is created due to the submittal of the counter offer, such as after every deal, every day or every two days.

Before being provided with the ability to make purchases, however, buyers are required to register with the system and provide their information that is stored in the user database 400 (see FIG. 2). The process associated with user validation and authentication is performed in accordance with standard authentication procedures. Therefore, if a buyer is not authorized to access the system to make purchases, they will be denied the ability to checkout their product in the conventional shopping cart and complete their purchase until they have registered.

Pursuant to signing into the system, the buyer is provided with all information regarding the particular products he has selected under his/her pending items, such as online price (i.e., Buy Now), latest auction price shown by the auction result 350, and his own counter-offering price, as well as his payment and shipping information. It should be appreciated that the buyer always has the option to adjust his transaction information, especially his counter-offering price based on the latest auction result that he is provided with via email and/or text message according to his pre-selected notification frequency. Alternatively, the buyer may adjust his/her maximum price according to the response from the market. The buyer counter offers are stored in a buyer counter offer database 320.

After counter-offering the maximum price for the particular product, the buyer guarantees the purchase by providing payment information 310, such as a credit card number or some other form of payment guarantee, such as an account associated with an on-line service, such as PayPal™.

The seller is provided with the continual option to sell its products through the auction model 300, irrespective of the status of the items for sale under the direct sale model. Here, each product has an associated auction schedule with auction windows that show the period during the day or the following several days in which the auction is available. An auction window 340 will open with a predefined time interval, which is adjustable for each particular product based on the number of buyers and sellers that are available in the market for the specific product.

During the interval in which an auction window 340 is open, the auction window is closed to the biding process but can be used to review market conditions. Here, the quantity in the Price Stack 330 that is associated with each price range is dynamic to thereby reflect the number of available buyers in the current market. Based on this information, the seller can select a sales strategy before the auction window opens.

A transaction history database 360 provides a medium in which to store completed transactions that are provided once a closed auction window 350 occurs. As described previously, the seller inventory database 510 is used to store the product information associated with the products for sale that are provided by each seller.

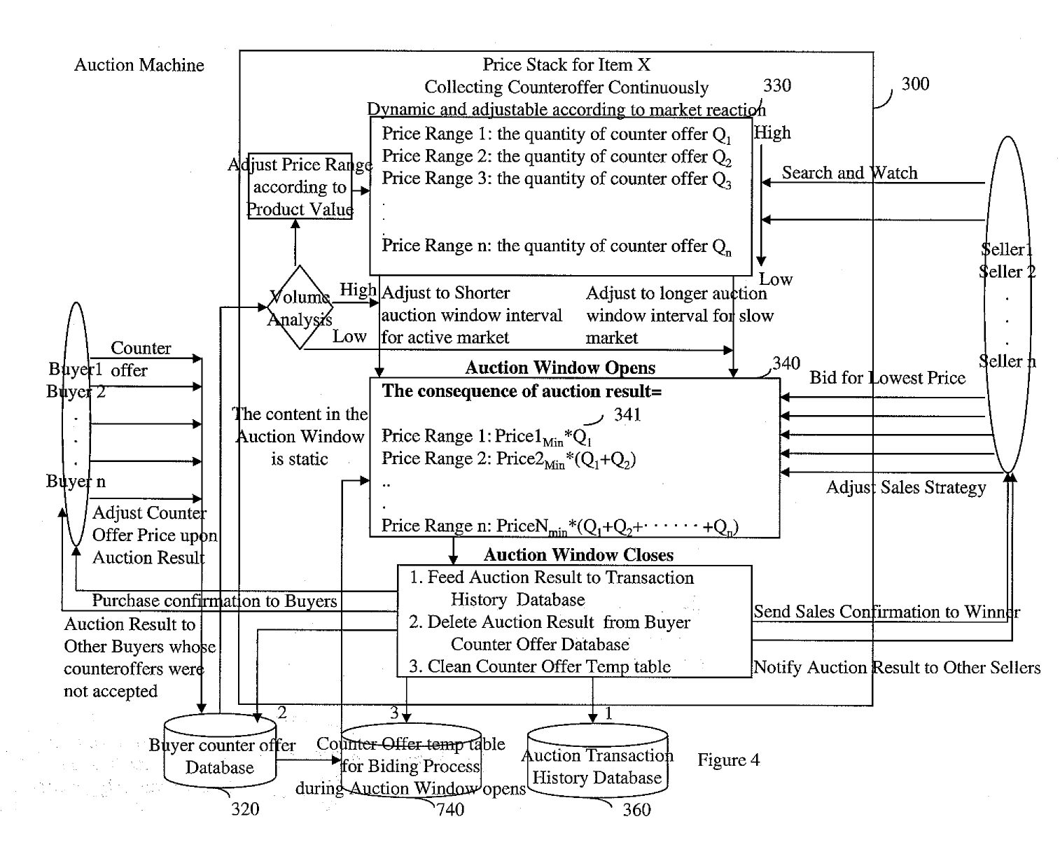

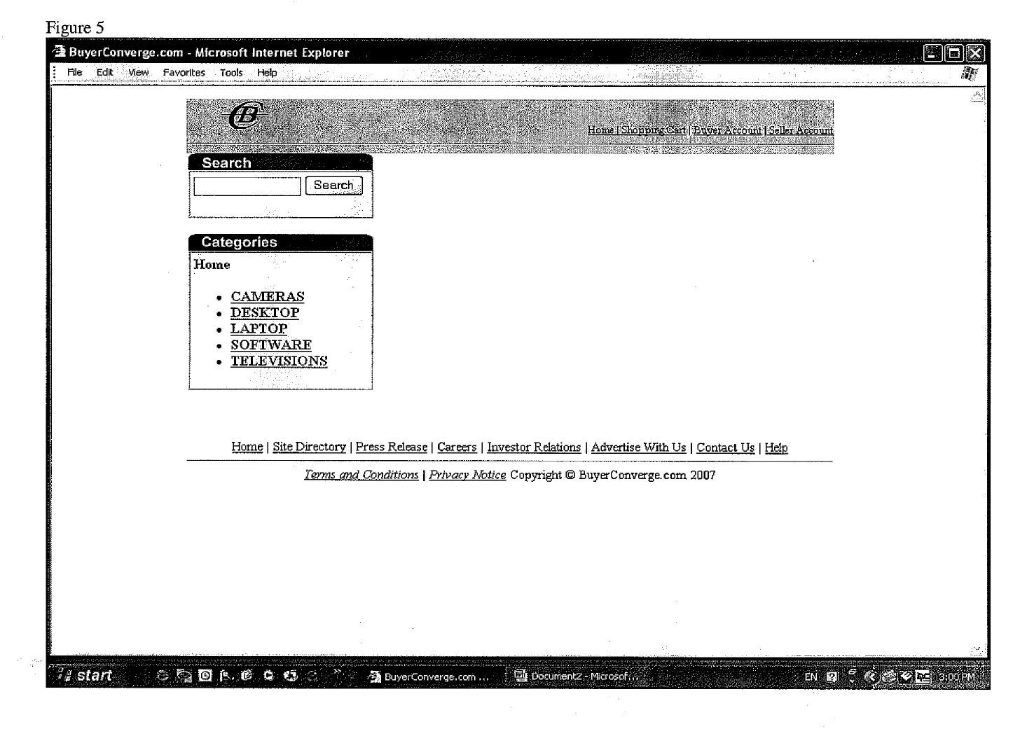

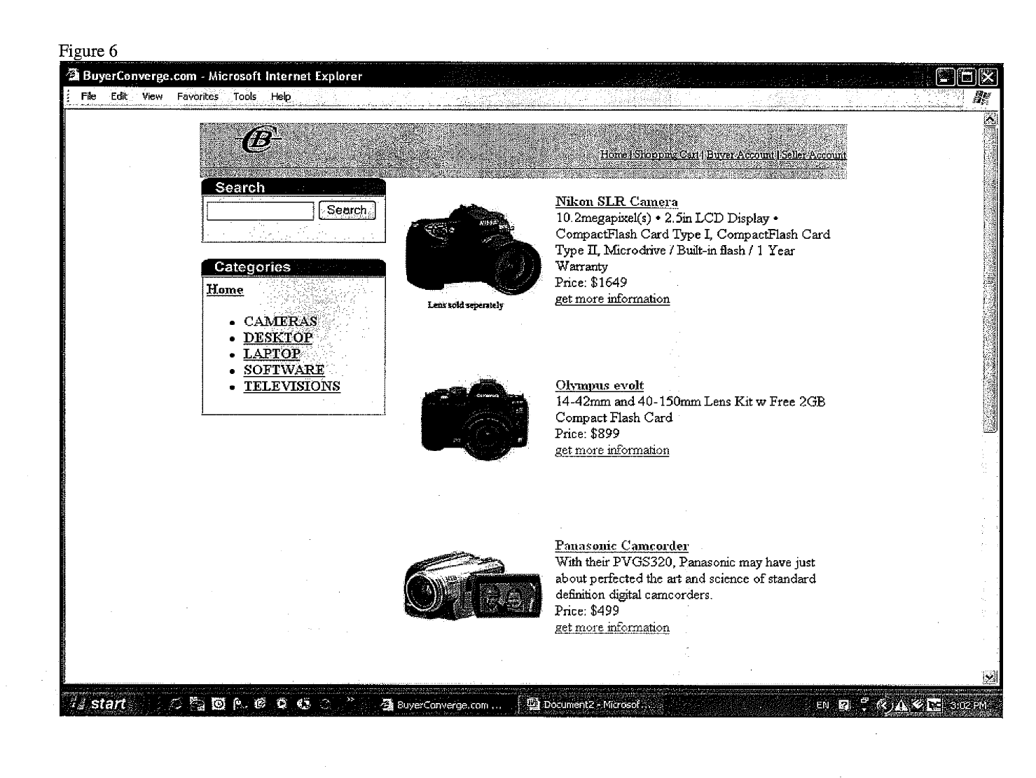

FIG. 4 is a block diagram illustrating the operational flow of the auction model 300 of FIG. 3. With specific reference to FIG. 4, the auction window 340 opens with a predefined time interval, which is adjustable for each particular product based on the number of buyers and sellers that are available in the market for the specific product. To prevent the buyers from losing the advantages associated with volume purchasing and to prevent the sellers from running out of inventory, which would violate the no back-order policy, the market is monitored and the auction window interval is adjusted to a shorter interval for an active market and a longer interval for a slower market. In this manner, competition is promoted among different sized sellers.

During the interval in which the auction window 340 is open, the auction window is closed to the biding process but can be used to review market conditions, i.e., the content in the auction window remains static. Here, the quantity in a Price Stack 330 that is associated with each price range is dynamic to thereby reflect the number of available buyers in the current market. The Price Stack comprises different price ranges for the same product, along with a group of buyers associated with each price range. The counter-offer information from the buyer is accumulated and grouped as price ranges in the Price Stack.

When the auction window 340 opens to the biding process, the Price Stack becomes frozen, where the quantity on each price range remains unchanged even though the counter-offer process continues at the buyer side. Sellers can review the condition of the Price Stack during the auction window interval, and attend enter their bids when the auction window 340 is open. The seller that offers the lowest asking price during the period that the auction window 340 is open will “win” the transaction, i.e., the right to sell the specific product to a group of buyers. On the other hand, the buyer who has counter-offered a price that is above the lowest price bided by the seller will enjoy this lowest sale price. After the auction window closes, an adjustment of the Price Stack will occur to ensure that it is more closely aligned to the price that the sellers are willing to accept for their products. Here, the information is supplied to the transaction history database 360, the auction result is deleted from the buyer counter-offer database 320 and a temporary counter offer database 740 is erased. The sellers can also adjust their asking price according to the available number of the buyers and their counter-offering price. In this manner, a fair market value is eventually established that is based on an equivalent of the supply and demand for the specific product.

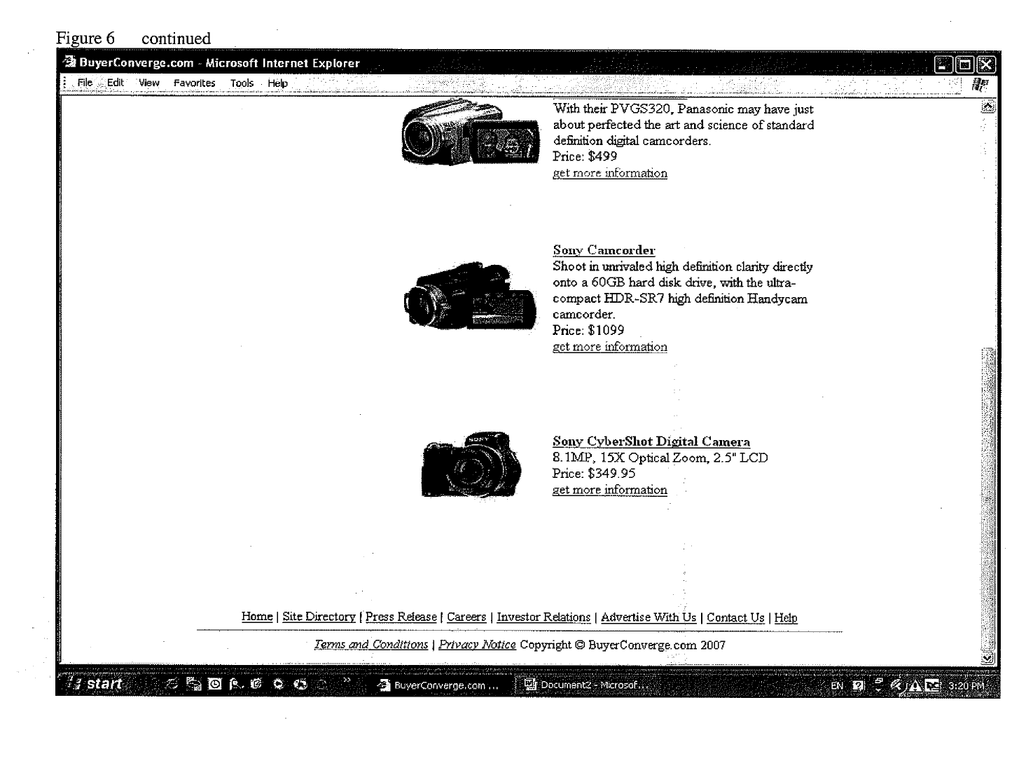

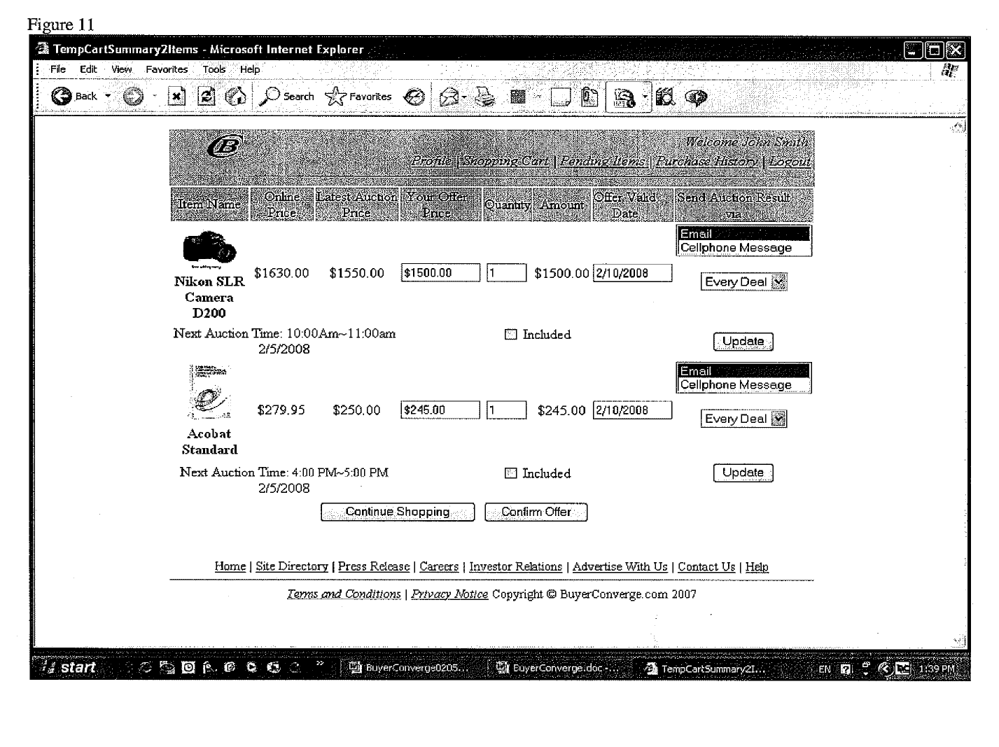

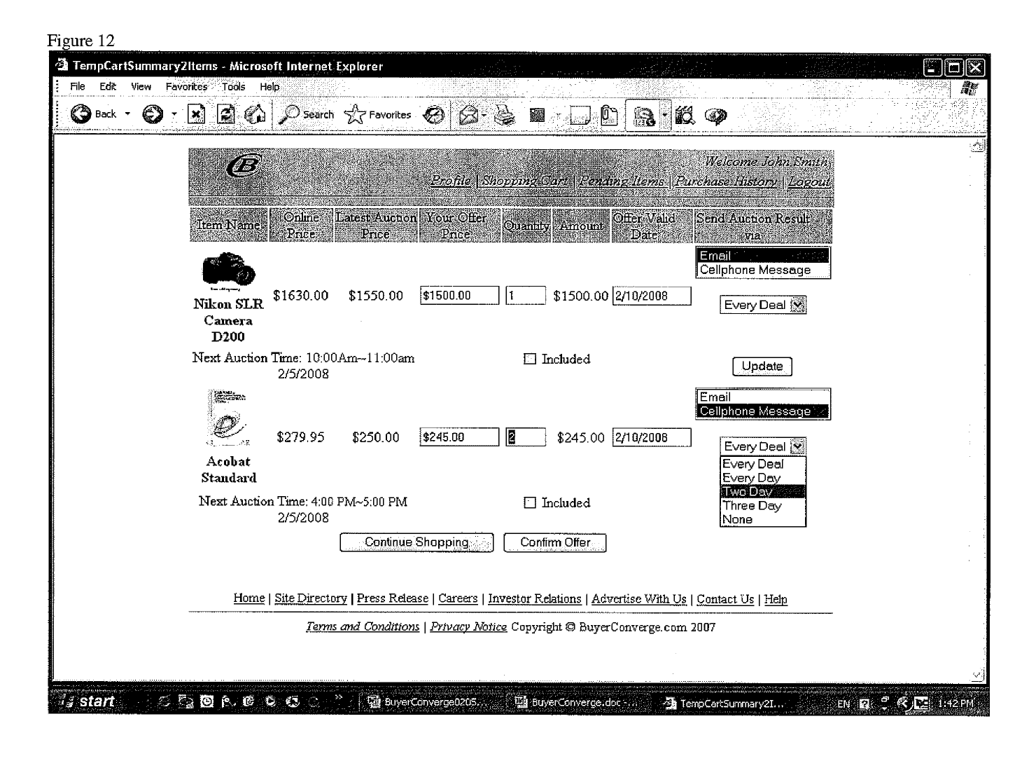

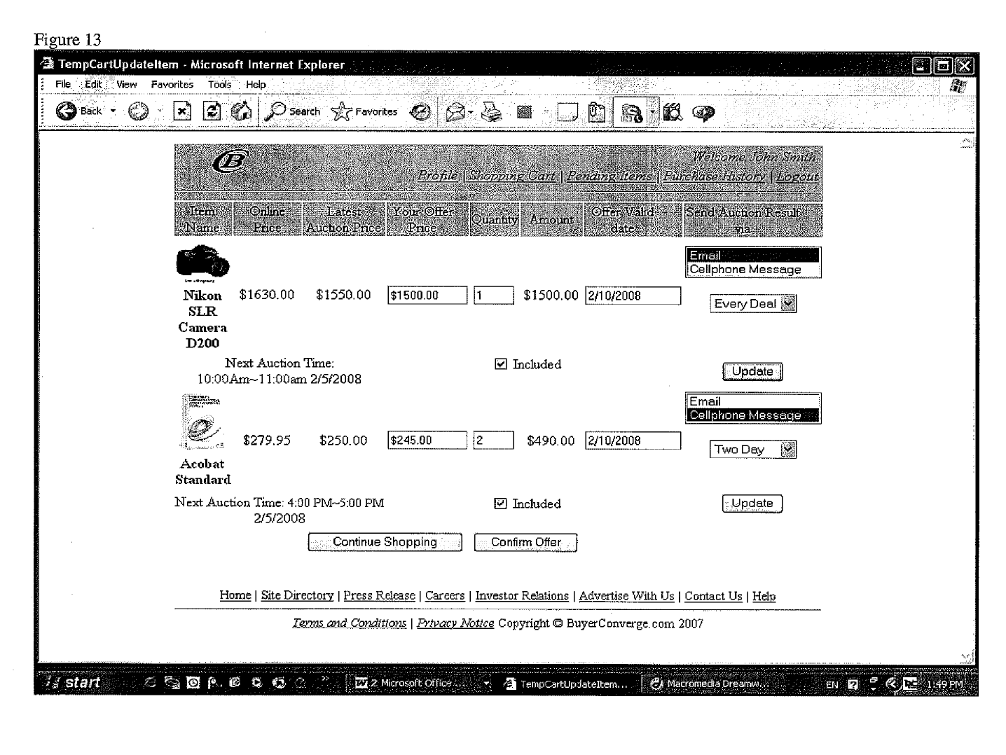

FIGS. 5-26 are screen captures of a transaction process in accordance with the system and method of the invention. Initially, a buyer, such as John Smith, browses the Internet and arrives at the website that is provided in accordance with the invention. Here, the buyer can locate a product using either a search function associated with a search engine or the categories menu to scroll down to a specific product in demand, as shown in FIGS. 5 and 6.

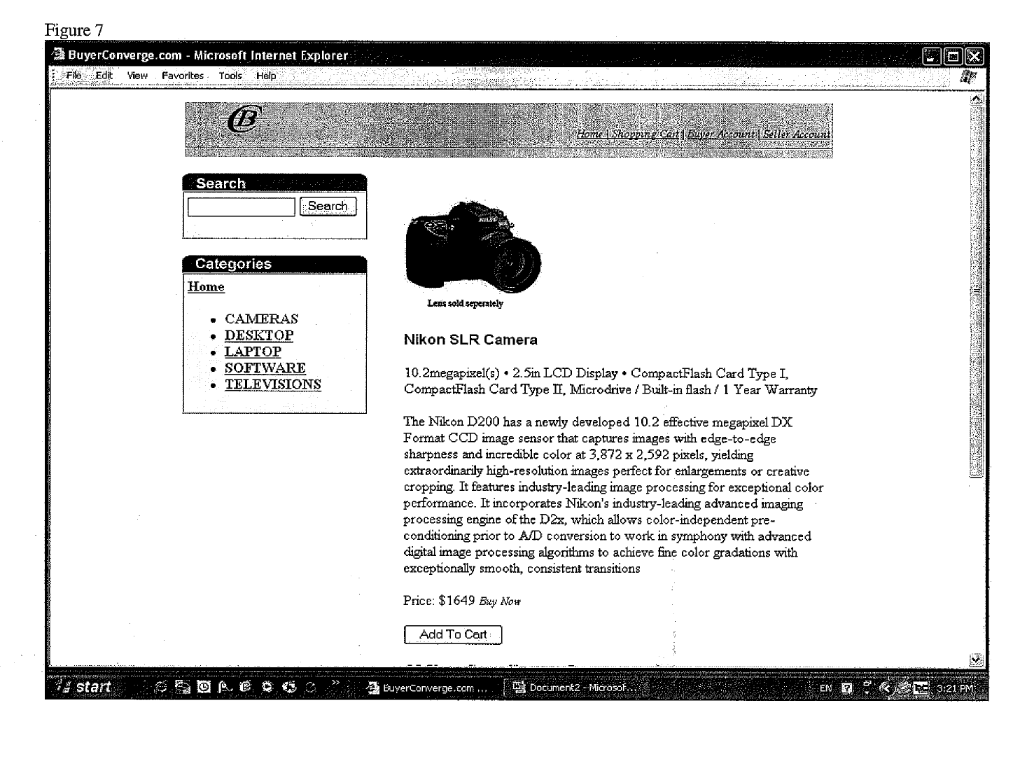

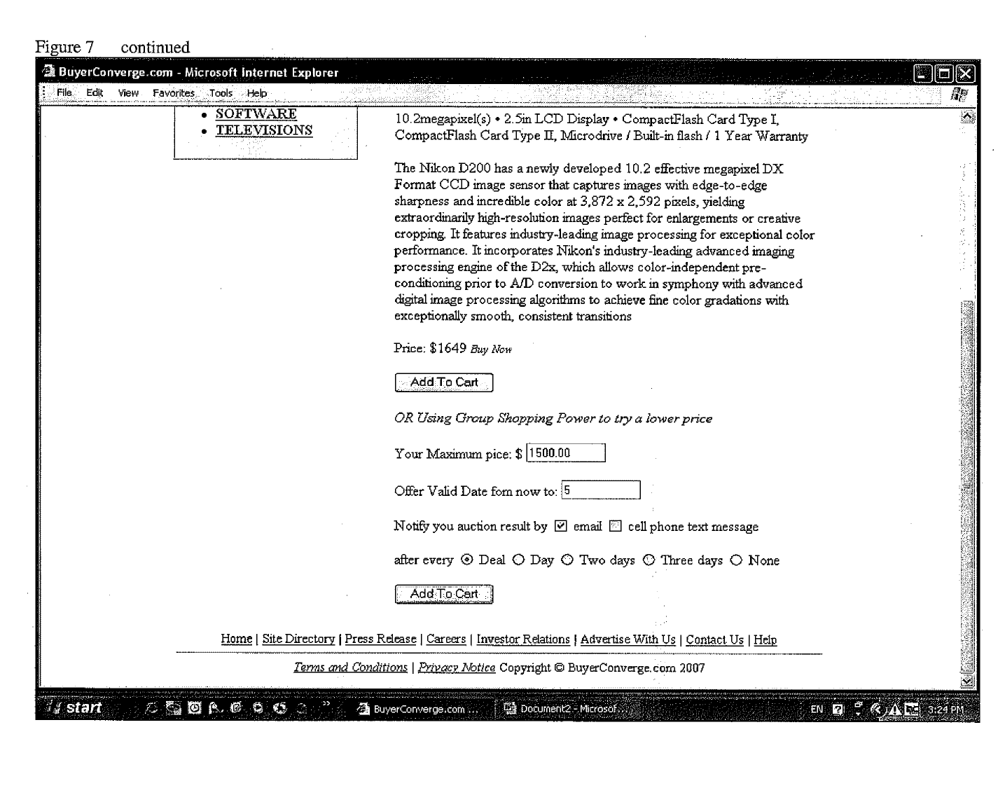

As illustrated in FIG. 7, after identifying the specific product in demand, John is provided with two choices, i.e., either to immediately buy the product if he is satisfied with the Buy Now price of, for example, $1649, or John may counter-offer a lower price that is the maximum price that he is willing to pay. In the illustrated example, John chooses the second option, i.e., by offering his maximum price, an offer valid date, a notification method (e.g., email or text message), and his desired notification frequency (e.g., after every Deal, every day or every two days). In accordance with the preferred embodiment, the buyer is provided with a suggested period that is at a more intensive frequency to the rush buyer.

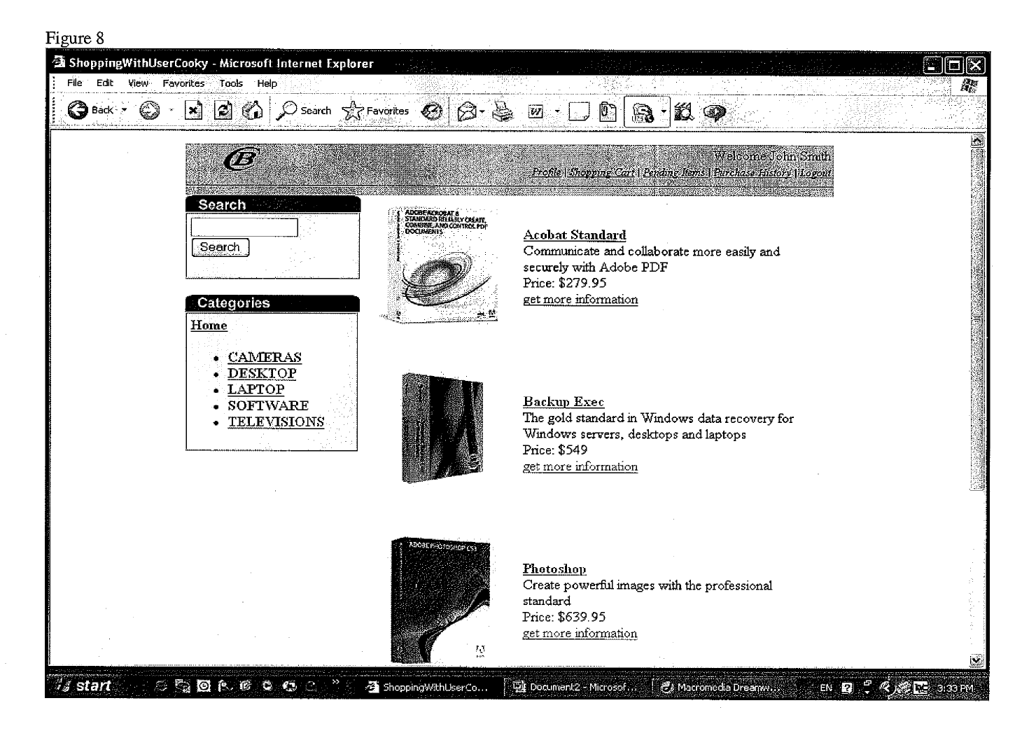

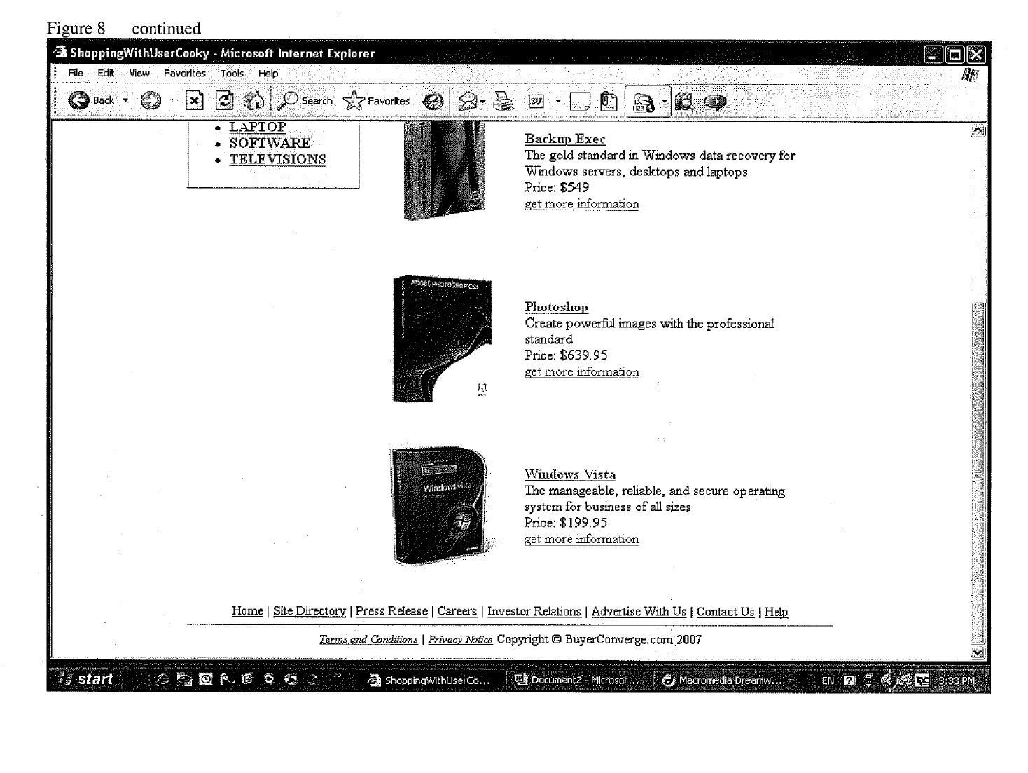

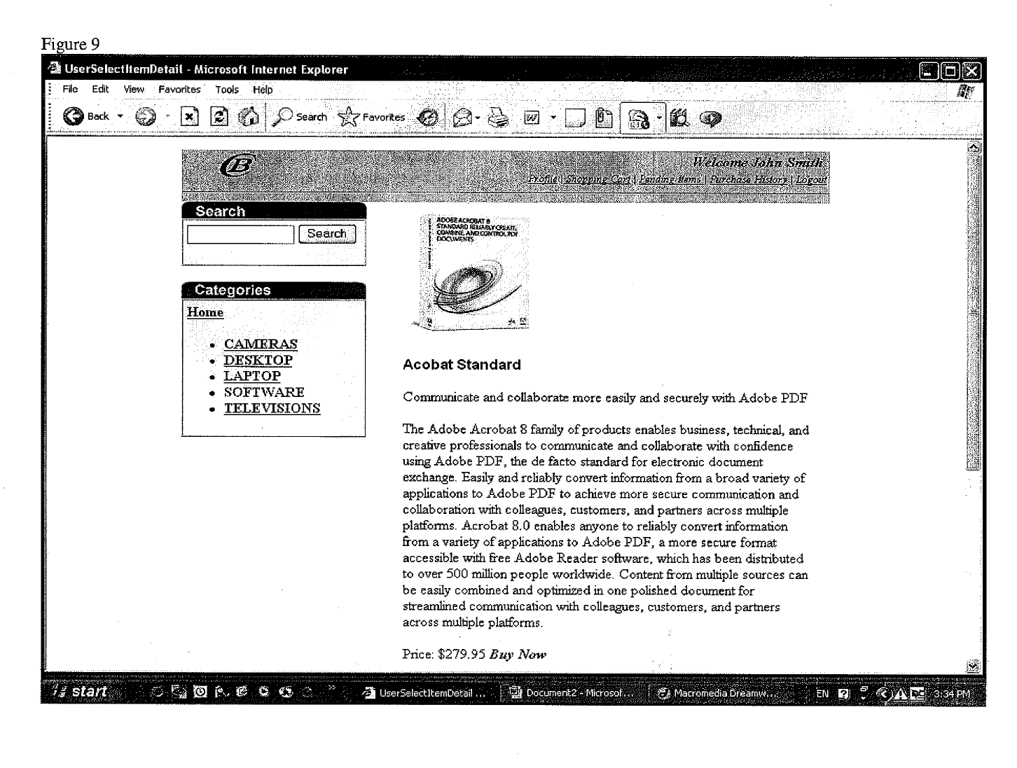

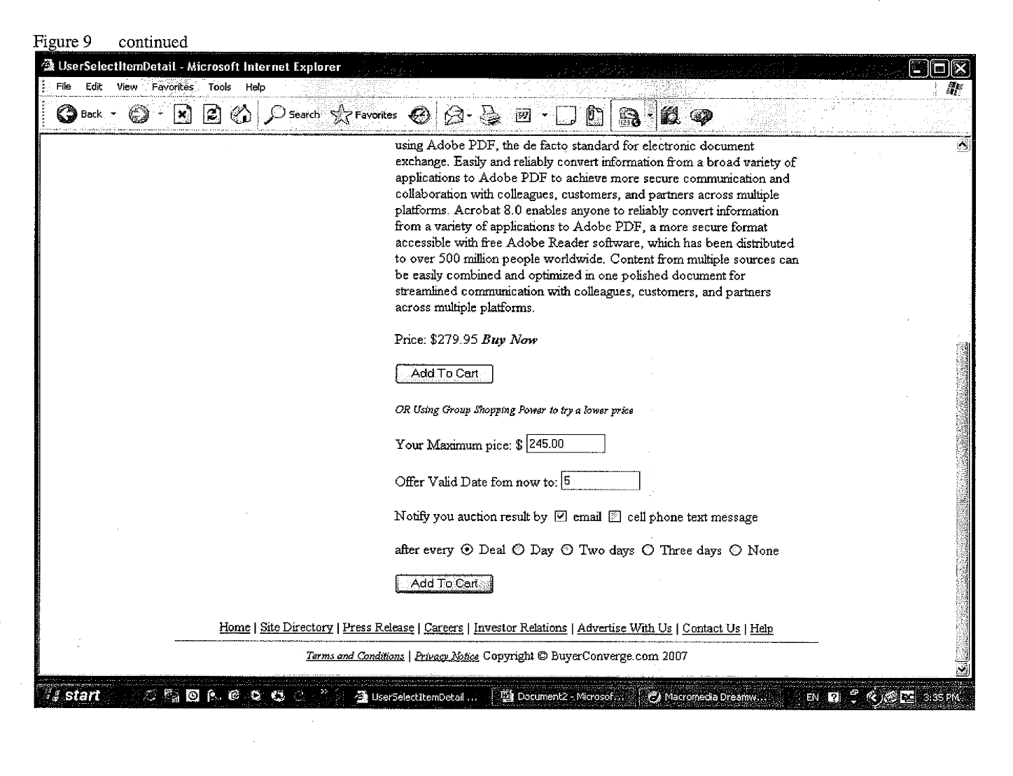

Turning to FIGS. 8 and 9, the specific product selected by John is added to the shopping cart in a known manner. If desired, the process outlined by way of illustration may be repeated to thereby allow John to continue shopping for additional products.

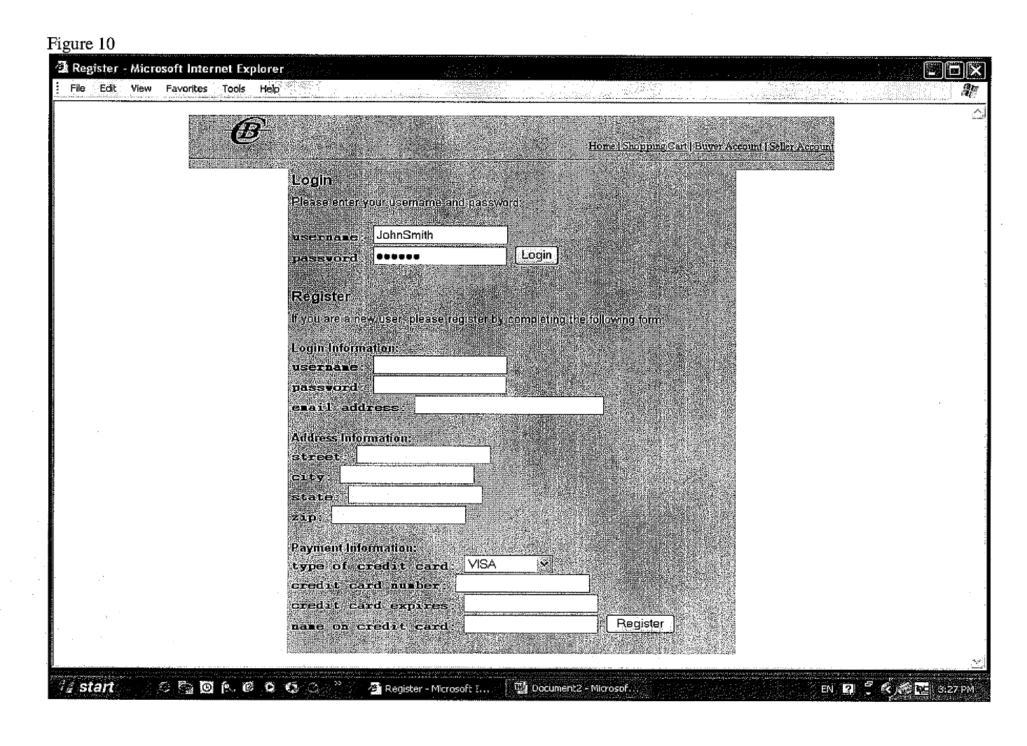

FIGS. 10-12 provide an illustration of the process associated with completing the transaction. John is required to log into a personal account that is pre-established with the website provided in accordance with the invention. Upon logging in, John may perform “check out” of the items in the shopping cart. Before checking out, however, John is provided with the option to modify the content of his order, such as the quantity and the notification method and frequency. It should be understood that a 0 quantity is used to remove items from the shopping cart. It is also possible for John to adjust his maximum price that he is willing to pay in accordance with the latest auction price associated with his selected products.

Before completion, if the transaction is pursuant to the direct sale model, then John is provided with other available product information from the seller. If the price is acceptable to John, then he can purchases all the items simultaneously to thereby save shipping costs.

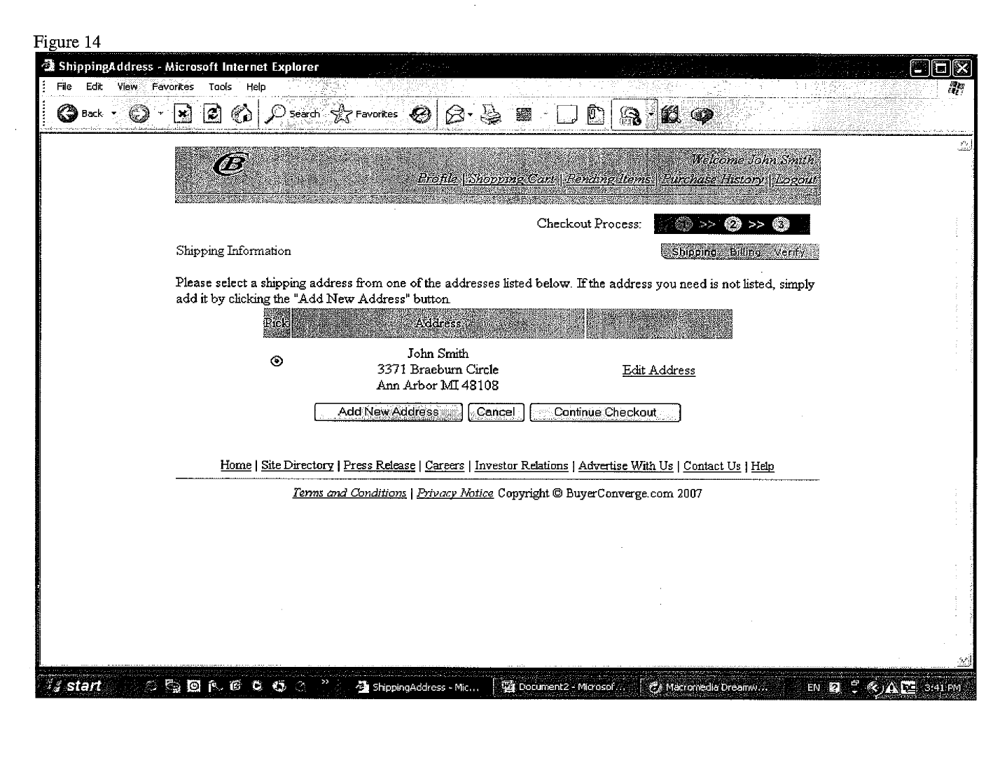

If John provides credit card and shipping information that differ for each selected item, then John is provided with the option to exclude the items in his check out list at this time, and to return check out the remaining items at later point in time, as illustrated in FIG. 13.

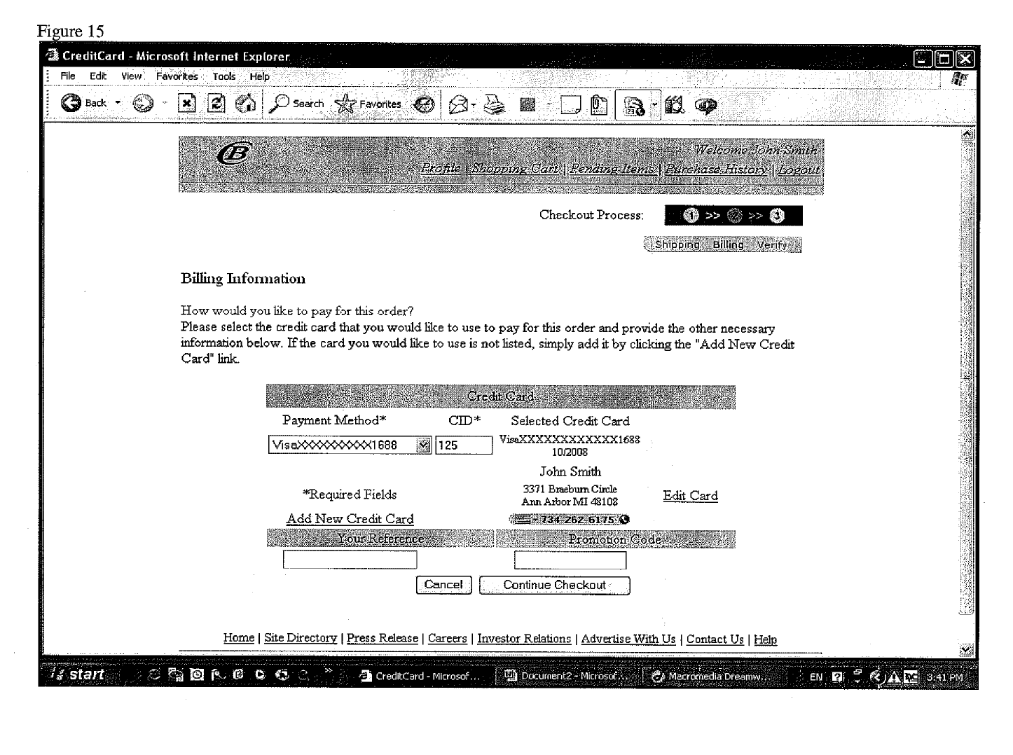

Referring to FIGS. 14 and 15, after John has checked out his shipping information is requested, along with his credit card information, which is used to guarantee his purchases. If the transaction is in accordance with the auction model, the guarantee amount is the maximum amount that John is willing to pay for the product in the auction in which John is participating. Here, it should be readily appreciated that the actual amount of the transaction could be much lower than the maximum amount that John is willing to pay.

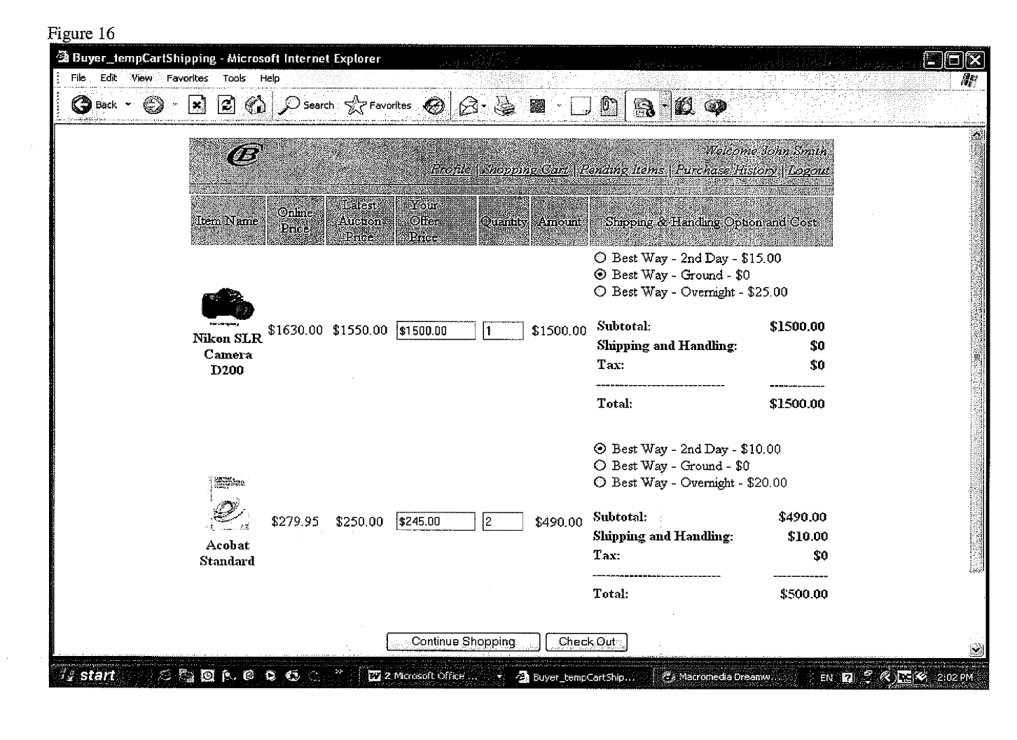

FIG. 16 shows that John can choose a separate shipping method for each selected product before the transaction information is submitted and passed to the system for bid processing for the seller.

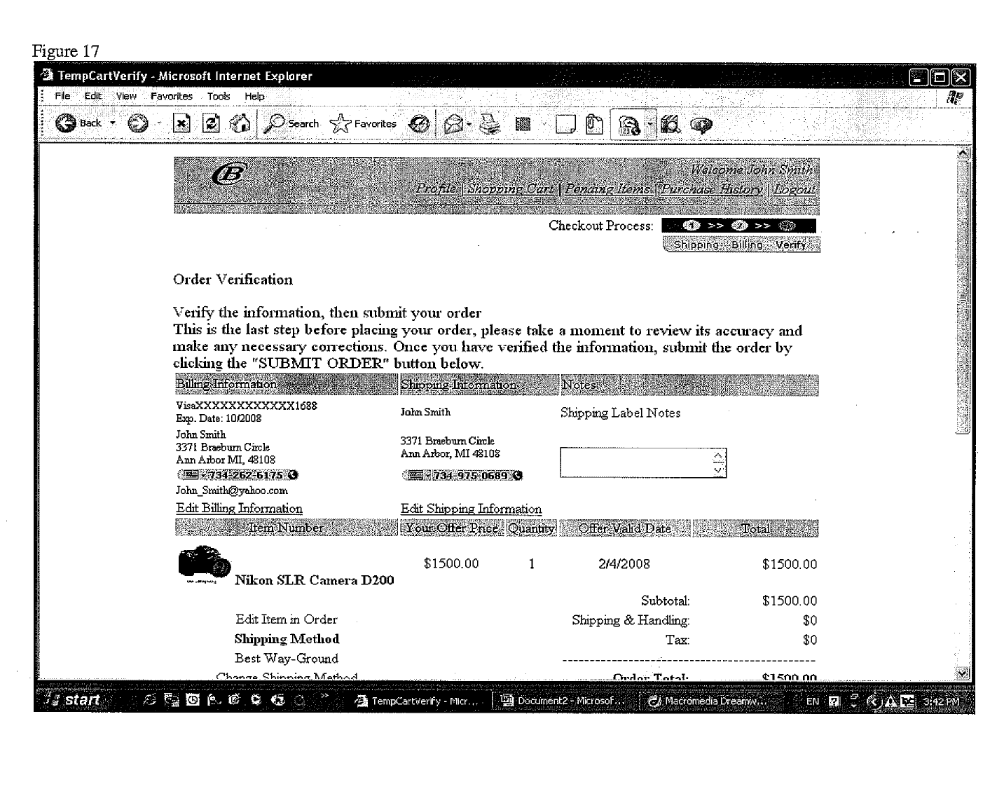

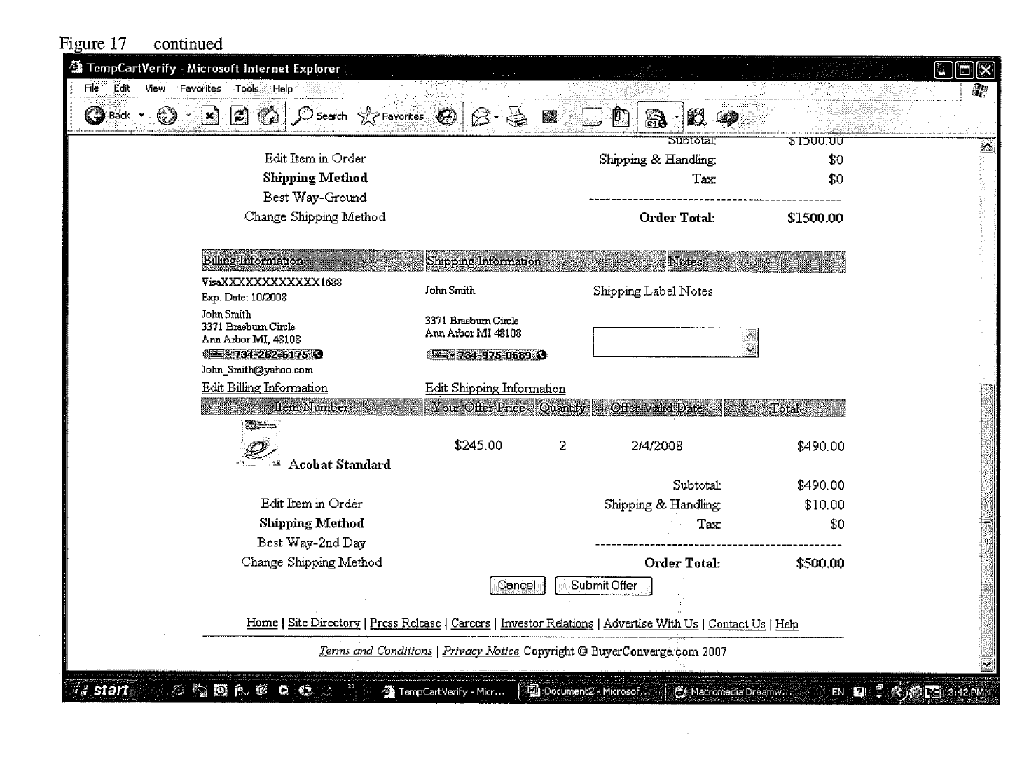

The screen capture of FIG. 17 is directed to the auction model. Here, the check out price for the product does not comprise a lump sum for all items but, rather, comprises an individual price total for each specific product because the auction is conducted on a product specific basis.

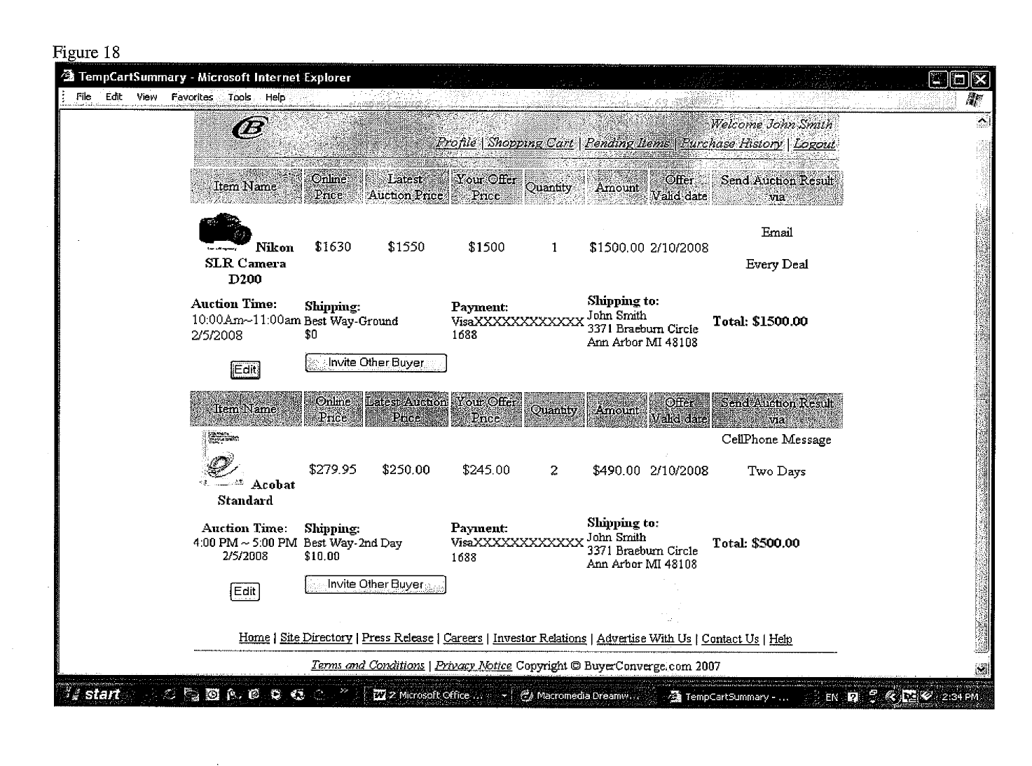

With reference to FIG. 18, if John has executed a Buy Now transaction, then the purchase process has completed and there is no further processing. If the transaction is not a Buy Now transaction, then other transactions become pending items to await the final auction result. The buyer John is provided with all information regarding the particular products he has selected under his pending items, such as online price (i.e., Buy Now), latest auction price, and his own counter-offering price, as well as his payment and shipping information. It should be appreciated that John always has the option to edit his transaction information, especially his counter-offering price based on the latest auction result that he is provided with via email and/or text message according to his pre-selected notification frequency.

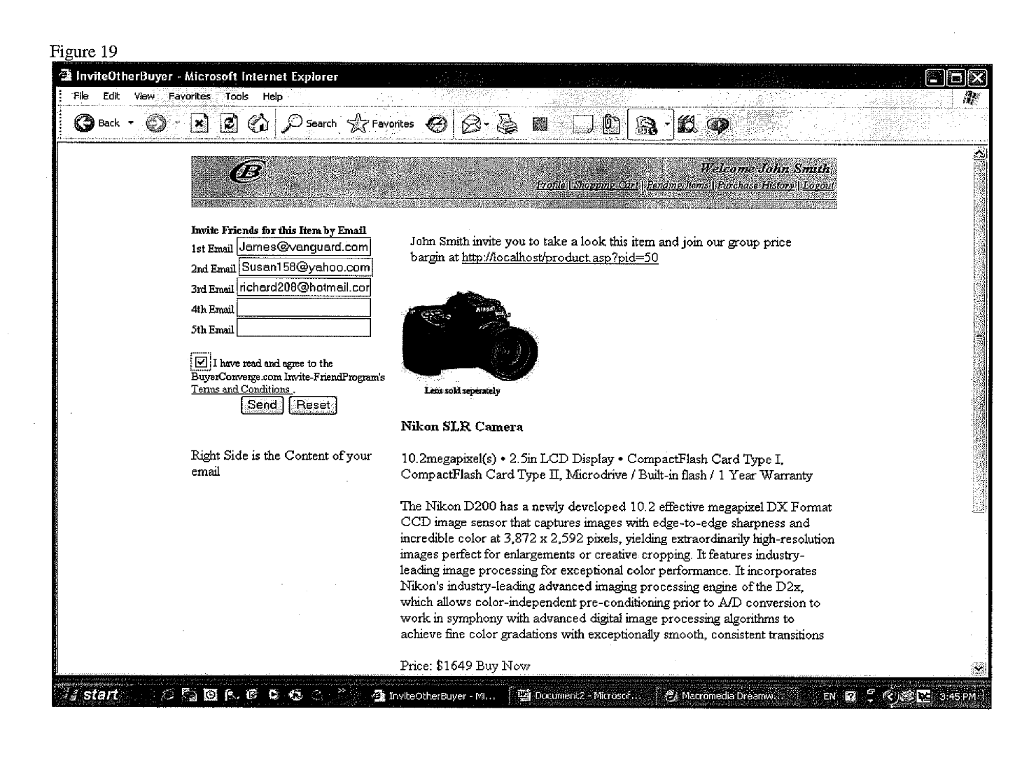

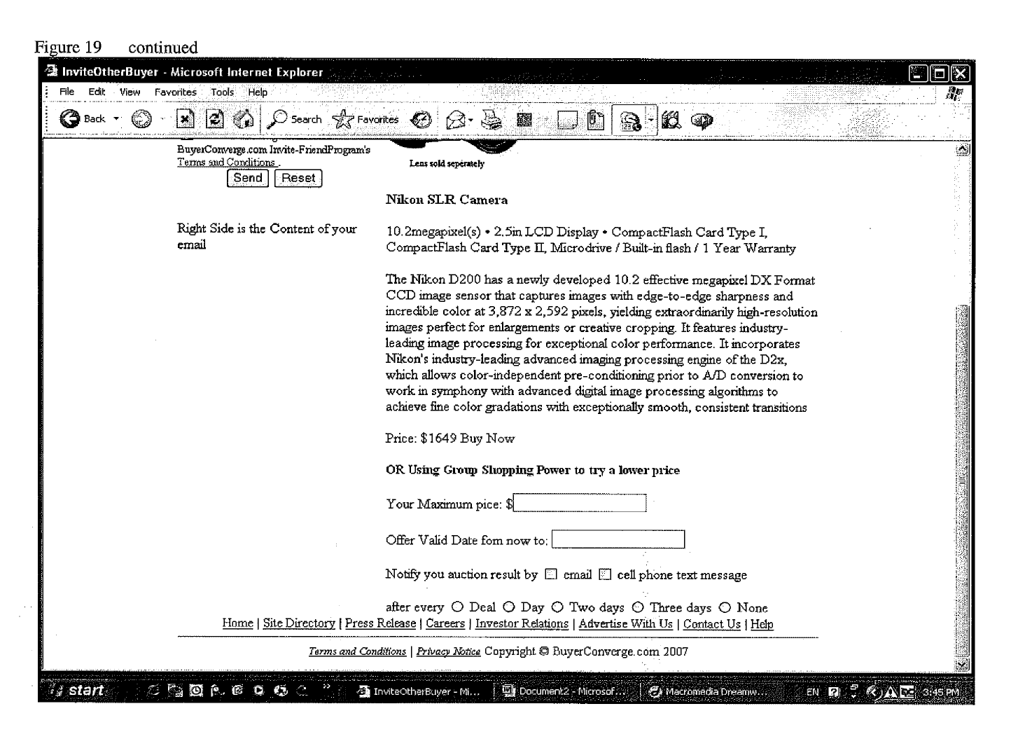

As shown in FIGS. 18 and 19, the system and method of the invention provides the website with an “Invite Other Buyer” button, located under the pending items of John, which allows him to recommend the product to his friends and invite them to join and make offers for his selected product to strengthen his position. That is, a greater number of buyers of a product at the same price maximizes the probability of acceptance of the price by the seller.

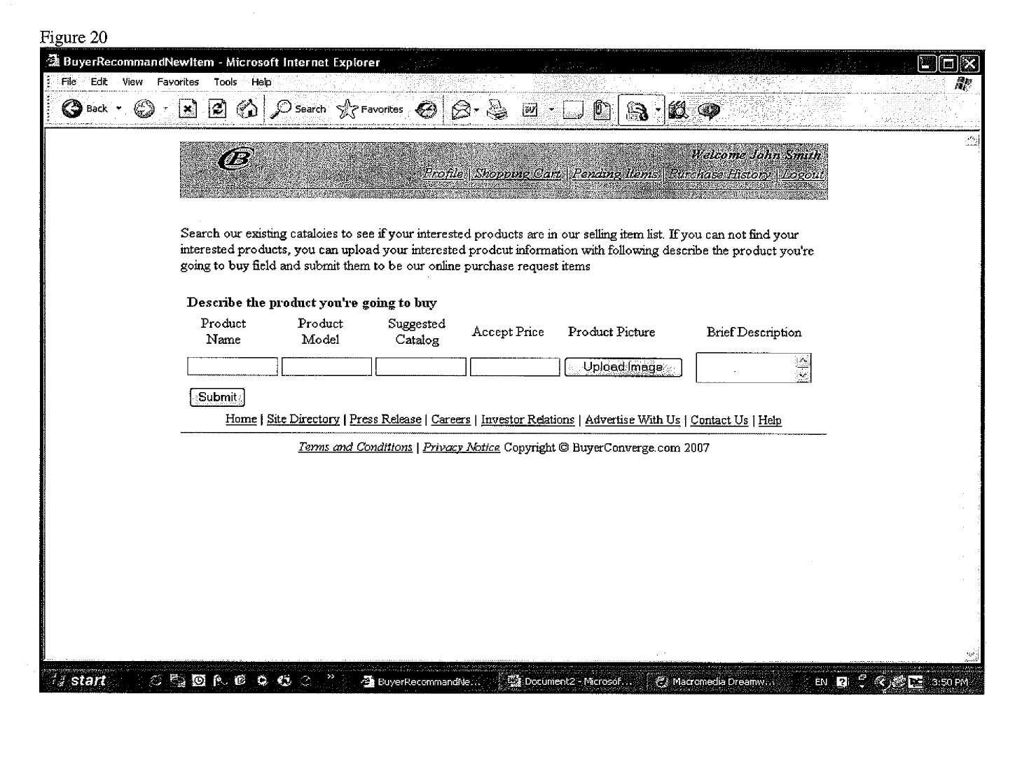

Referring to FIG. 20, if John is unable to locate his desired product through the website provided pursuant to implementing the system and method of the invention, then he can upload related product information, which will be maintained in a demanded product database that can be searched by buyers and sellers. The demanded product database is provided with a counter that counts the number of visitors and collects the contact information of each visitor. Upon the seller uploading the product information and offering a price for this particular product, it is removed from the demanded product database and made available on-line for all types of transactions, i.e., transactions that comply with the direct sale model and the auction model. A notification is sent to all potential buyers who provide their contact information at the website. In this manner, John uploads the new product information and establishes a potential new market for products.

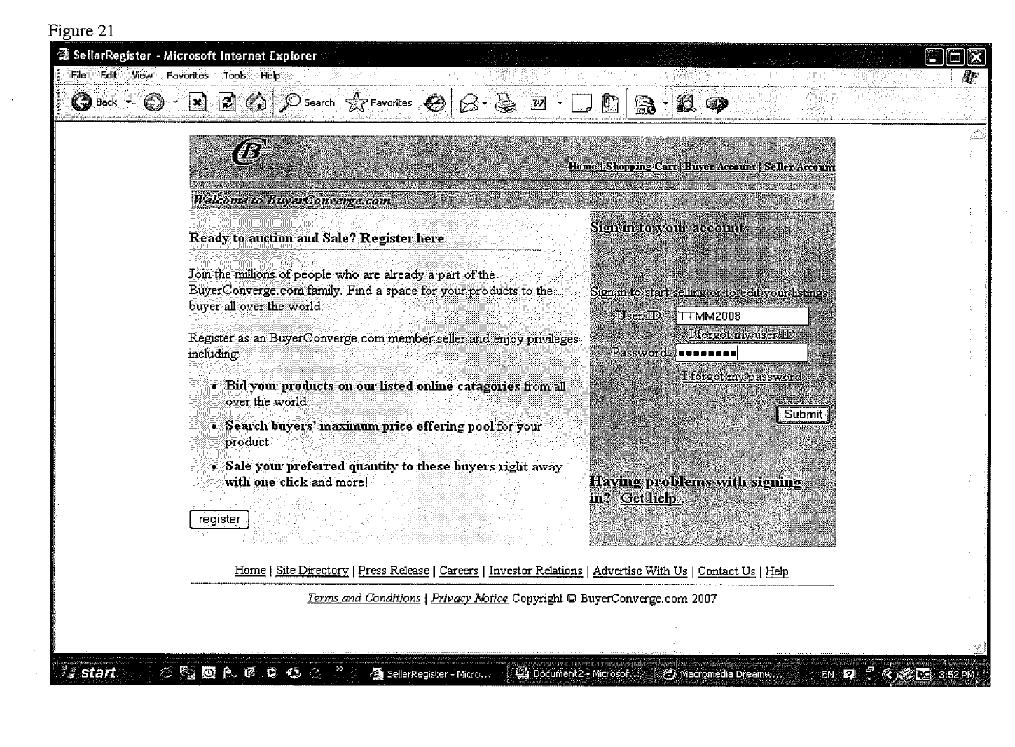

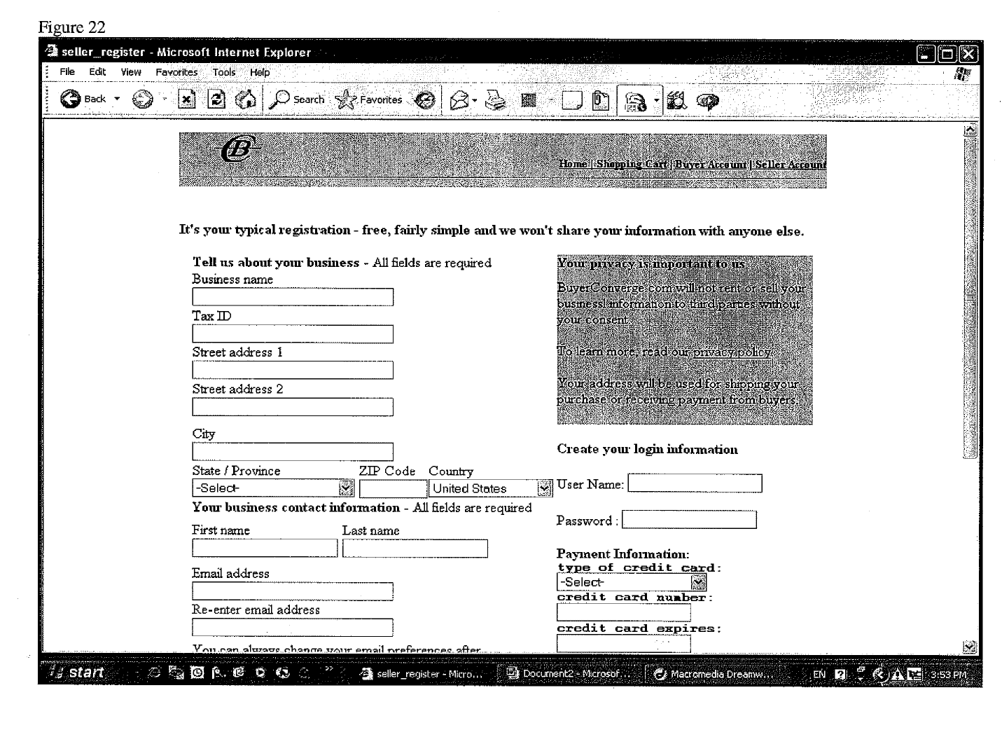

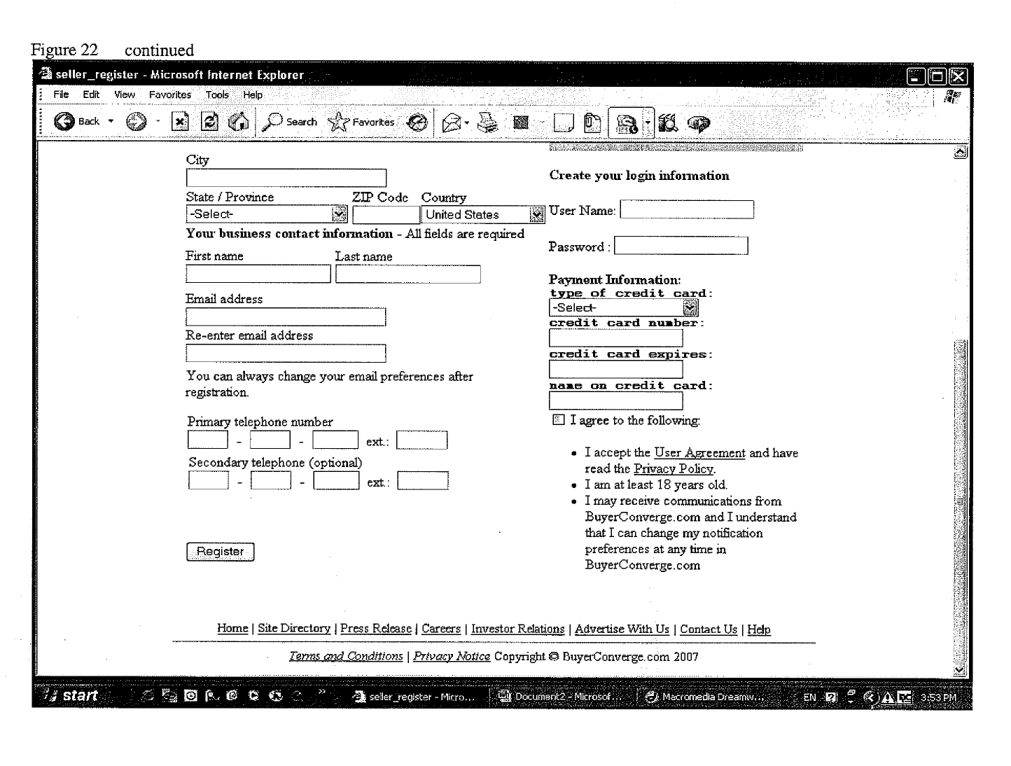

The website provided in accordance with the system and method is anonymous on the seller side. Consequently, it is a key desire to control the quality of sellers that offer their products. Sellers are thus required to open an account and log into the website before entering into any type of transaction, as illustrated in FIGS. 21 and 22. An internal credit rating system is used to assign to each seller an initial rating based on the result of a credit check. The credit rating of the seller is adjusted based on feedback received from the buyers. The internal credit rating of the seller affects the fee schedule, with a lower service charge being provided to sellers having a good or high credit rating and a higher service charge being provided to seller having a low or bad credit rating. The credit rating is a threshold that may be varied depending on overall market conditions. Sellers thus having a credit rating that exceeds the threshold will be excluded from the market. Sellers are provided with the ability to check their credit rating, corresponding fees and feedback from the buyers in a “Credit Report” that has maintained under their own account.

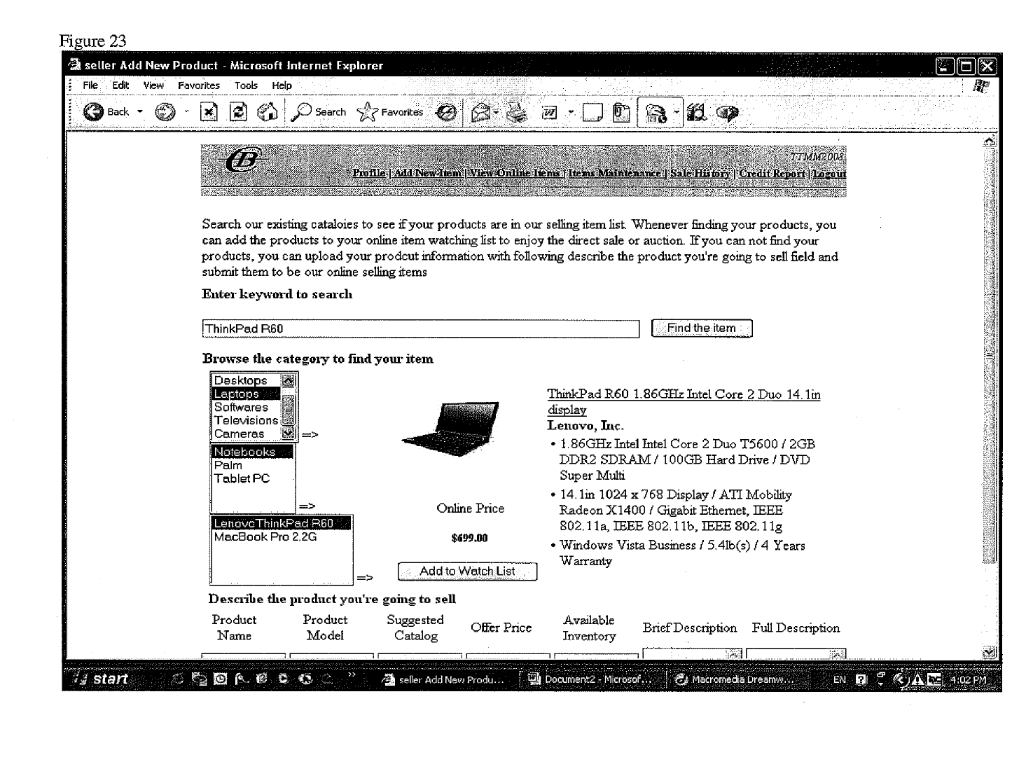

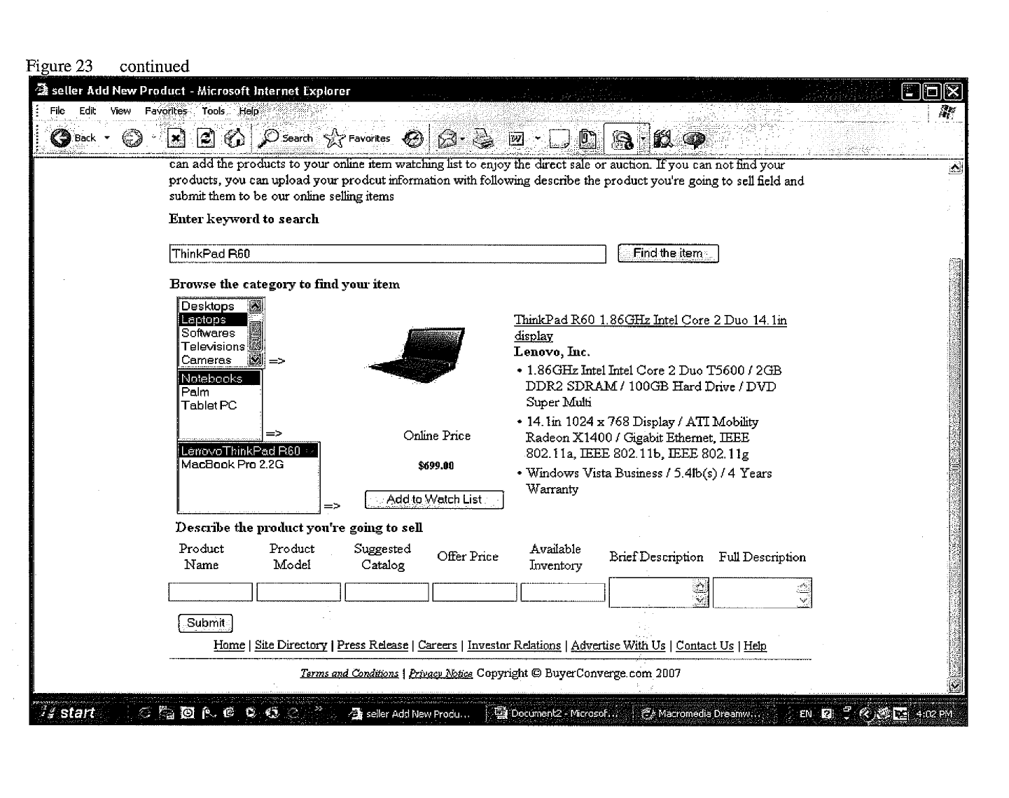

FIG. 23 illustrates a seller having the user name TTMM2008 is logged in at the website provided in accordance with the invention. This seller is provided with the option to use a search function to identify or use a category to access the product he/she wishes to sell, and to thereby add the product to a watch list via a watch list tab or click button. If the product is not available through the website, then the seller can upload new product information and his offering price to attract potential buyers of the product.

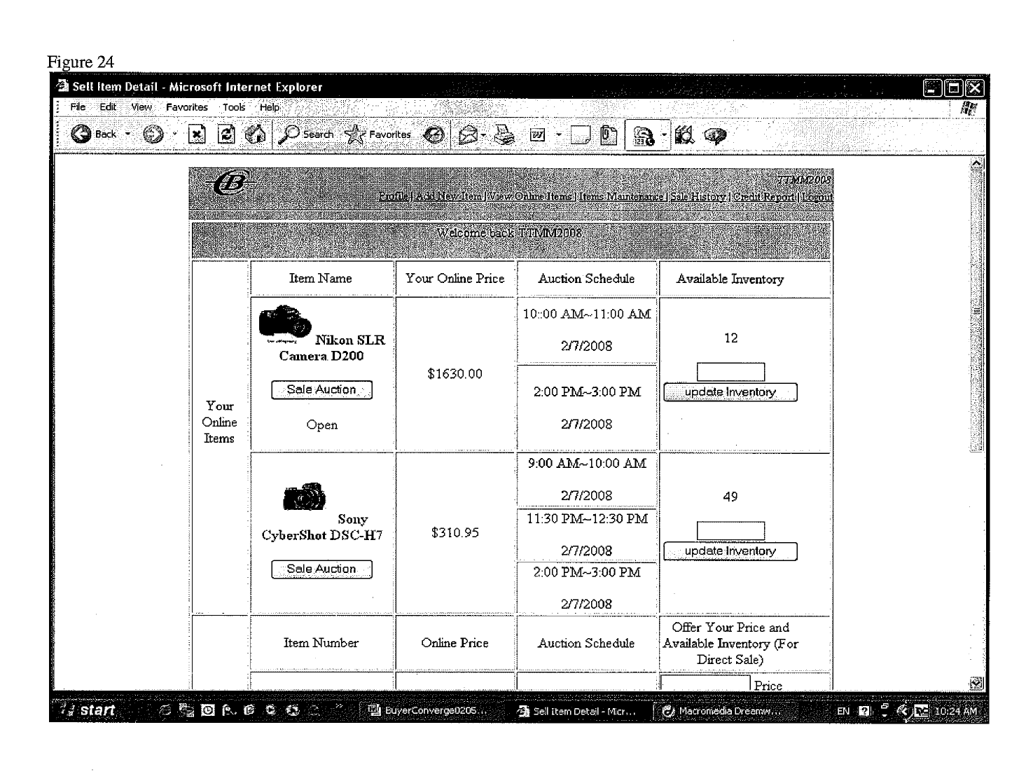

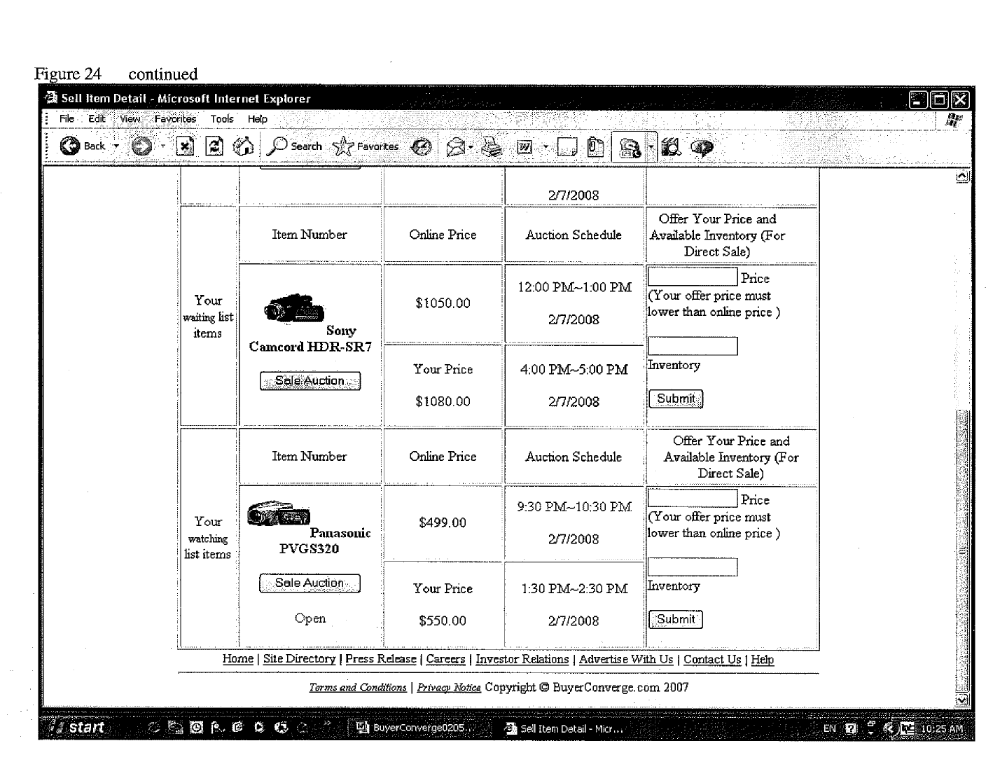

Referring to “View Online Items” shown in FIG. 24, there are three exemplary statuses of selling items, such as on-line items, waiting list items and watch list items. In the present example, on-line items are items for which the seller has entered into an exclusive direct sale right agreement via the website, where the seller has agreed to maintain a predetermined inventory level such that back-orders for specific product do not occur. The waiting list items are items having one of next several lowest prices (i.e., the next three lowest prices indicated in the example), maintenance of certain inventory level, and are ready for sale if they become the on-line items due to exhaustion of the inventory or a price change of previous on-line items.

Watch list items are items without the above-mentioned price features, and do not possess the inventory level maintenance requirement, where these products are being held until the seller arrives at a new sales strategy. It is possible to change the status of items listed for sale based on the supply side market conditions.

Moreover, the seller is provided with the continual option to sell its products through the auction model, irrespective of the status of the items for sale under the direct sale model. Each product has an associated auction schedule with windows that show the period during the day or the following several days in which the auction is available. An auction window will open with a predefined time interval, which is adjustable for each particular product based on the number of buyers and sellers that are available in the market for the specific product. To prevent the buyers from losing the advantages associated with volume purchasing and to prevent the sellers from running out of inventory, which would violate the no back-order policy, the market is monitored and the auction window interval is adjusted to a shorter interval for an active market and a longer interval for a slower market. In this manner, competition is promoted among different sized sellers.

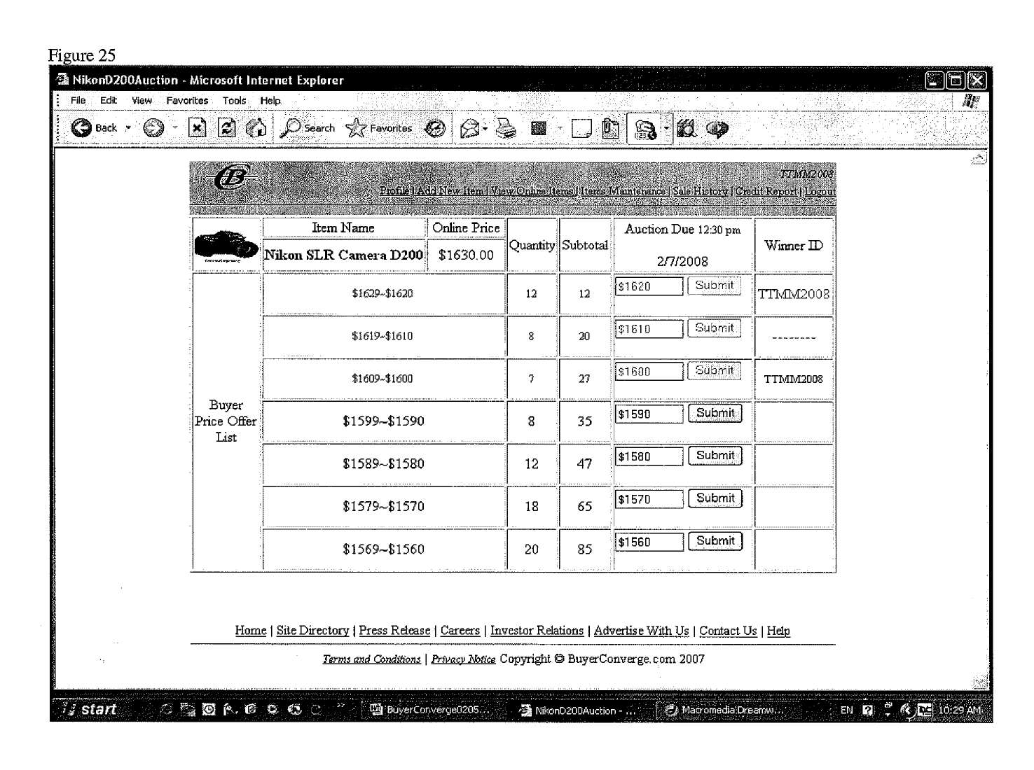

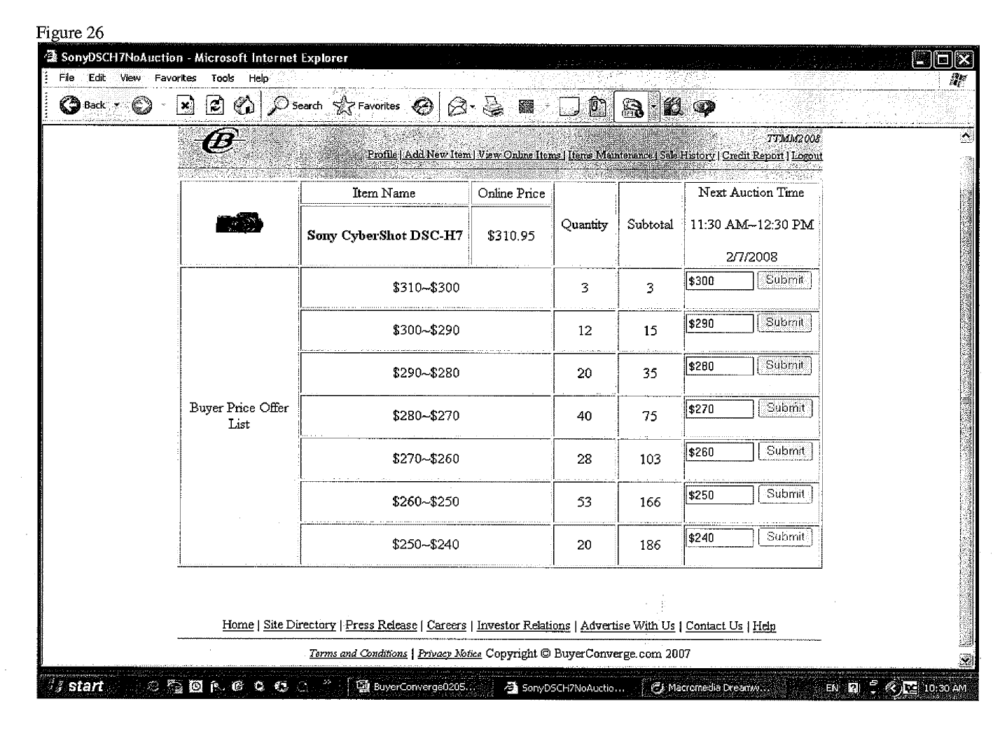

FIGS. 25 and 26 illustrate two statuses of the auction window, i.e., “opened” and “closed”. With reference to FIG. 25, when the auction window opens, the Price Stack becomes frozen. The Price Stack comprises different price ranges for the same product, along with a group of buyers associated with each price range. The quantity on each price range thus remains unchanged, even though the buyer counter-offering process continues. Here, the seller TTMM2008 has clicked the “Sale Auction” button located under the product icon, which is open, and has immediately attended to bidding process. If the auction window is closed, then the seller may still review the status of the Price Stack.

As shown in FIG. 25, there are seven price ranges, with a total of 85 buyers in the Price Stack for the selected product. Here, the seller TTMM2008 provided the highest bid price, i.e., from $1,629 to $1,620, which has a total number of 12 buyers that offered a price within the same range. After submitting the desired price to be received for the product, i.e., his bid, seller TTMM2008 is shown posted in the “Winner ID” column to indicate his commitment to sell the products to these 12 buyers at the price of $1,620. There is also a competitor awaiting the right to bid for the next highest price range from $1,619 to $1,610, which has 8 buyers that have offered a price within this range. After submitting the bid, the competitor's user name becomes posted in the Winner ID column that is visible only to the competitor and remains anonymous to other sellers. The competitor has a commitment to sell the products at the price of $1,610 not only to these 8 buyers but 20 buyers, which includes the 12 buyers from the highest price range.

In considering the profit margin and current inventory level, the seller TTMM2008 placed a bid for the third highest price range from $1,609 to $1,600, which has 7 buyers that entered an offer at this price. As shown in FIG. 25, seller TTMM2008 was also posted in the Winner ID column shown at the website. Until the auction window closes, no other sellers placed an acceptance price that was lower than the price bid by seller TTMM2008. Consequently, TTMM2008 “won” the transaction. Here, a total of 27 buyers, having offering prices at or above $1,600, can “close-the-deal” and enjoy the price that is $30 lower than the Buy Now price by virtue of the advantageous volume purchasing.

After the auction window closes, a confirmation email is sent to these buyers to inform them of the final price. The information of the buyers, such as purchase volume, shipping address and payment information, is provided to the seller for subsequent processing. A notification email or text message is also sent to all buyers who did not complete the deal based on their notification frequency option. These buyers have the opportunity to modify their maximum price that they are willing to pay for the product based on the result of the latest auction. After every auction window closes, an adjustment of the Price Stack will be occur to ensure that it is more closely aligned to the price that the sellers are willing to accept for their products. The sellers can also adjust their asking price according to the available number of the buyers and their counter-offering price. In this manner, a fair market value is eventually established that is based on an equivalent of the supply and demand for the products.

As shown in FIG. 26, during the interval in which an auction window is open, the auction window is closed to the biding process but can be used to review market conditions. Here, the quantity in the Price Stack that is associated with each price range is dynamic to thereby reflect the number of available buyers in the current market. Based on this information, the seller can select a sales strategy before the auction window opens.

Thus, while there are shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. Moreover, it should be recognized that structures shown and/or described in connection with any disclosed form or embodiment of the invention may be incorporated in any other disclosed or described or suggested form or embodiment as a general matter of design choice.

What is claimed is:

1. A method for reducing a distance between an understanding and an expectation of a buyer and seller for a price of a particular product that is offered for sale, comprising:
initiating, at a direct sale module of an application server, a competitive bidding process among sellers for a right to upload the particular product to a database for sale, said product descriptions having a minimum required price;
uploading the particular product to the database from the seller which won the competitive bidding process to the right to upload the particular product;
receiving purchase offers from buyers for the uploaded particular product at the direct sale module of the application server; and
providing the particular product to the buyer via the direct sale module of the application server based on a purchase offer equaling the minimum required price for the particular product.

2. The method of claim 1, wherein the minimum required price is a “Buy Now” price which is displayed to buyers at a website.

3. The method of claim 1, further comprising:
accumulating, at an auction sale module of the application server, purchase offers from buyers if the purchase offers are less than the minimum required price for the particular product, the purchase offers being accumulated and grouped as a price range in a price stack of the auction sale module, the price range being adjustable in accordance with a price level of the particular product and a distance between the expectation of buyers;
monitoring purchase offers from the buyers at the auction sale module of the application server to determine a level of demand for the particular product;
adjusting a time interval of an auction window at the application server based on the level of demand for the particular product; and
providing an auction result to buyers to permit the buyers to provide revised purchase offers for the particular product.

4. The method of claim 3, further comprising:
receiving, at the application server, a maximum price offer that a buyer is willing to pay for the particular product; and
receiving at least one of a time period in which the maximum price offer should remain valid, a notification method and a frequency that the buyer will be informed of an auction result.

5. The method of claim 4, wherein the frequency is one of after every deal, every day and every two days.

6. The method of claim 4, further comprising:
receiving from the buyer adjustments of the maximum purchase price offer according to a market response to the maximum purchase price offer that the buyer is willing to pay and a number of buyers available on each price range for the particular product.

7. A method for reducing a distance between an understanding and an expectation of a buyer and seller for a price of a particular product that is offered for sale, comprising:
accumulating, at an auction sale module of an application server, purchase offers from buyers which are less than a minimum required price for the particular product, the purchase offers being accumulated and grouped as a price range in a price stack of the auction sale module, the price range being adjustable in accordance with a price level of the particular product and a distance between the expectation of buyers;
monitoring purchase offers from the buyers at the auction sale module of the application server to determine a level of demand for the particular product;
adjusting a time interval of an auction window at the application server based on the level of demand for the particular product; and
providing an auction result to buyers to permit the buyers to provide revised purchase offers for the particular product.

8. The method of claim 7, further comprising:
receiving, at the application server, a maximum price offer that a buyer is willing to pay for the particular product; and
receiving at least one of a time period in which the maximum price offer should remain valid, a notification method and a frequency that the buyer will be informed of an auction result.

9. The method claim 7, further comprising:
sending invitations from a buyer to other buyers to purchase the particular product and augment a bargaining position of the buyer during an offering process.

10. The method of claim 7, wherein the price stack comprises a composite of different price ranges for the particular product, wherein a group of buyers is associated with each price range.

11. The method of claim 7, wherein the price stack is dynamic such that current market conditions are reflected to indicate demand from buyers on each price range, said price stack only being visible to the sellers.

12. The method of claim 7, wherein the sellers are provided with an auction window that is a function of the auction sale module such that sellers obtain price information of the buyers comprising a stack of different price ranges for the same particular product having a group buyer associated with each price range.

13. The method of claim 7, wherein the price stack becomes unchanged when the auction window is opened.

14. The method of claim 13, wherein the time interval of the auction window is adjusted for each particular product based on a number of available buyers and sellers.

15. The method of claim 7, further comprising:
adjusting the time interval of the auction window to a shorter interval for an active market; and
adjusting the time interval of the auction window to a longer interval for a slower market.

16. The method of claim 7, further comprising:
receiving adjusted minimum prices from the sellers at the application server based on counter offers from the buyers and bidding prices from other sellers for the particular product.

17. An application server configured to reduce a distance between an understanding and an expectation of a buyer and seller for a price of a particular product that is offered for sale, the application server comprising:
a direct sale module configured to initiate a competitive bidding process among sellers for a right to upload the particular product to a database for sale, said product descriptions having a minimum required price;
wherein the direct sale module is additionally configured to receive purchase offers from buyers for the particular product uploaded to the database and provide the particular product to a buyer based on a purchase offer equaling the minimum required price for the particular product.

18. The application server of claim 17, wherein the minimum required price is a “Buy Now” price which is displayed to buyers at a website.

19. An application server configured to reduce a distance between an understanding and an expectation of a buyer and seller for a price of a particular product that is offered for sale, the application server comprising:
an auction sale module configured to accumulate purchase offers from buyers which are less than a minimum required price for the particular product, the purchase offers being accumulated and grouped as a price range in a price stack of the auction sale module, the price range being adjustable in accordance with a price level of the particular product and a distance between the expectation of buyers;
wherein the auction sale module is additionally configured to monitor purchase offers from the buyers to determine a level of demand for the particular product, adjust a time interval of an auction window based on the level of demand for the particular product and provide an auction result to buyers to permit the buyers to provide revised purchase offers for the particular product.

20. The application server of claim 19, wherein a maximum price offer that the buyer is willing to pay for the particular product, and at least one of a time period in which the maximum price offer should remain valid, a notification method and a frequency that the buyer will be informed of an auction result are received at the application server.

21. The application server of claim 20, wherein the frequency is one of after every deal, every day and every two days.

22. The application server of claim 19, wherein the price stack comprises a composite of different price ranges for the particular product, wherein a group of buyers is associated with each price range.

23. The application server of claim 19, wherein the price stack is dynamic such that current market conditions are reflected to indicate demand from buyers on each price range, said price stack only being visible to the sellers.
